(19) United States
(12) Patent Application Publication
(10) Pub. No.: US 2020/0410090 A1
(43) Pub. Date: Dec. 31, 2020

(54) ROBUST VON NEUMANN ENSEMBLES FOR DEEP LEARNING

(71) Applicant: D5AI LLC, Maitland, FL (US)

(72) Inventor: James K. Baker, Maitland, FL (US)

(21) Appl. No.: 16/619,521

(22) PCT Filed: Jul. 16, 2019
(86) PCT No.: PCT/US19/41992

§ 371 Date: Dec. 5, 2019

Related U.S. Application Data
(60) Provisional application No. 62/713,282, filed on Aug. 1, 2018.

(51) Int. Cl. G06F 21/55; G06N 20/20

(52) U.S. Cl. CPC G06F 21/55; G06F 2221/034; G06N 20/20

(57) ABSTRACT

Computer-implemented systems and methods build and train an ensemble of machine learning systems to be robust against adversarial attacks by employing a probabilistic mixed strategy with the property that, even if the adversary knows the architecture and parameters of the machine learning system, any adversarial attack has an arbitrarily low probability of success.

### PRIORITY CLAIM

The present application claims priority to U.S. provisional patent application Ser. No. 62/713,282, filed Aug. 1, 2018, with the same title and inventor as identified above, and which is incorporated herein by referenced in its entirety.

### BACKGROUND

In recent years, great progress has been made in machine learning and artificial intelligence, especially in the field of multi-layer neural networks, which is called deep learning. However, it has also been discovered that deep neural network classifiers have a surprising and potentially dangerous vulnerability to deliberate adversarial attacks. As one example adversarial method, in image recognition problems, it is remarkably easy to cause a deep learning classifier to make a mistake. By making a change in each pixel that is so small that it is invisible to a human viewer, it is possible to cause a deep neural network classifier to classify an image as something that is completely different from the original answer. For example, it is possible to cause a classifier to misrecognize an image of a mouse as a lion, a house, a tricycle, or as anything else. Other methods make larger changes but change fewer pixels. Besides raising questions about the foundations of deep learning, this phenomenon is of major concern in computer security and public safety. Substantial efforts have been made to make deep learning classifiers robust against such adversarial attacks with only limited success. This problem is regarded as one of the most important and one of the most difficult unsolved problems in deep learning.

### SUMMARY

The present invention, in one general aspect, provides computer-implemented systems and methods for building and training an ensemble of machine learning systems to be robust against adversarial attacks. A preferred embodiment employs a probabilistic mixed strategy with the property that, even if the adversary knows the architecture and parameters of the machine learning system, any adversarial attack has an arbitrarily low probability of success. This mixed strategy shares some favorable properties with a von Neumann mixed strategy in the theory of finite, two-person, zero-sum games. In addition, this mixed strategy makes it difficult for an adversary to gather information about the behavior of the ensemble that could be used in designing an adversarial attack. Although a non-deterministic system based on a probabilistic mixed strategy is preferred, deterministic implementations are also shown. With adaptive training, a system that is technically deterministic is described that can match the performance of a non-deterministic von Neumann ensemble.

A variety of additional techniques that further improve the performance, robustness, and diversity of the system are also described. Examples comprise: (i) back propagation of a function of the output other than the primary objective of the machine learning system, (ii) using the derivatives of the function defined in (i) to characterize the sensitivity of the system to changes in the input, (iii) creating a secondary objective based on the derivatives computed in (ii), using modified activation functions to make the sensitivity of the system to changes in the input more prominent, (iv) using selected target values for the secondary objective to create diversity among ensemble members and among ensemble subsets, and many other special techniques. These and other potential benefits of the present invention will be apparent from the description that follows.

### BRIEF DESCRIPTION OF DIAGRAMS

Various embodiments of the present invention are described herein by way of example in conjunction with the following figures.

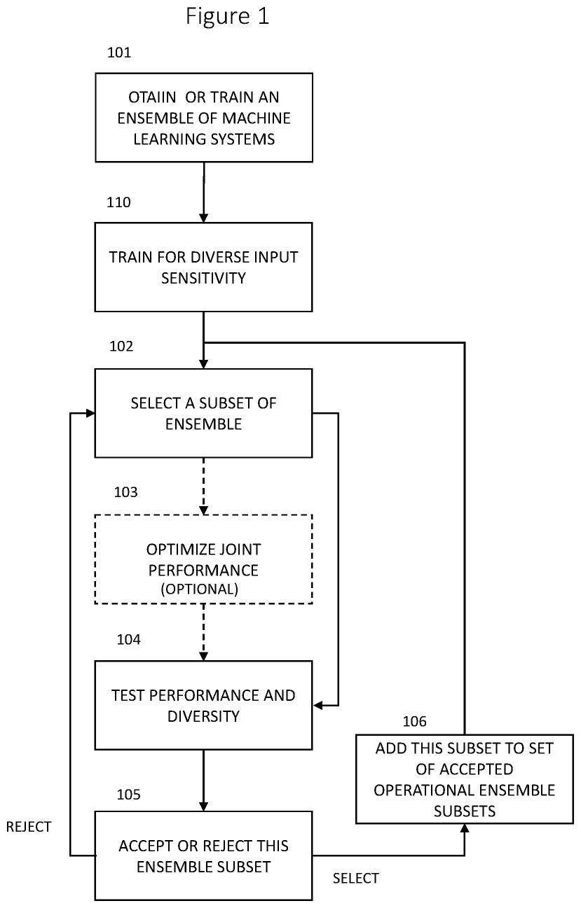

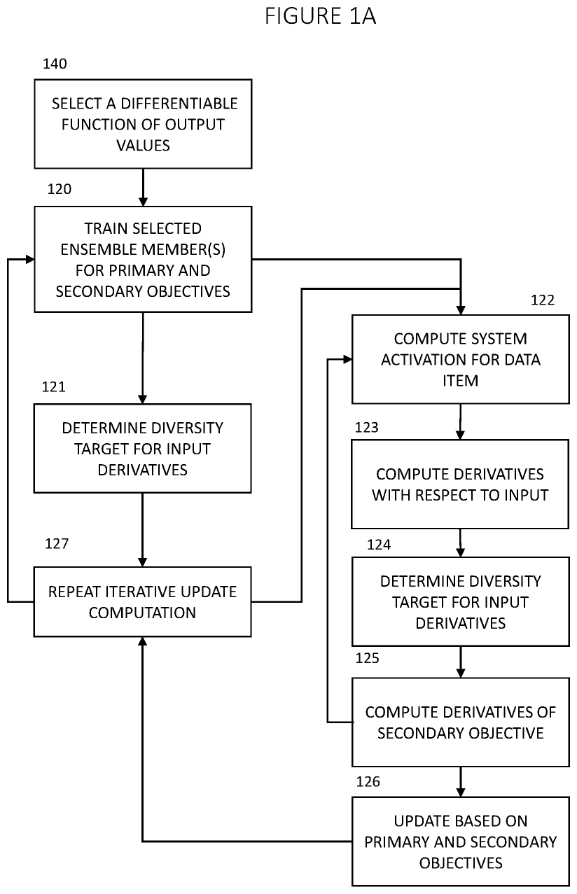

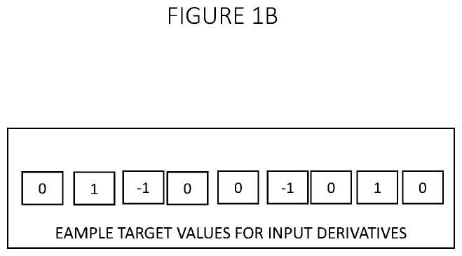

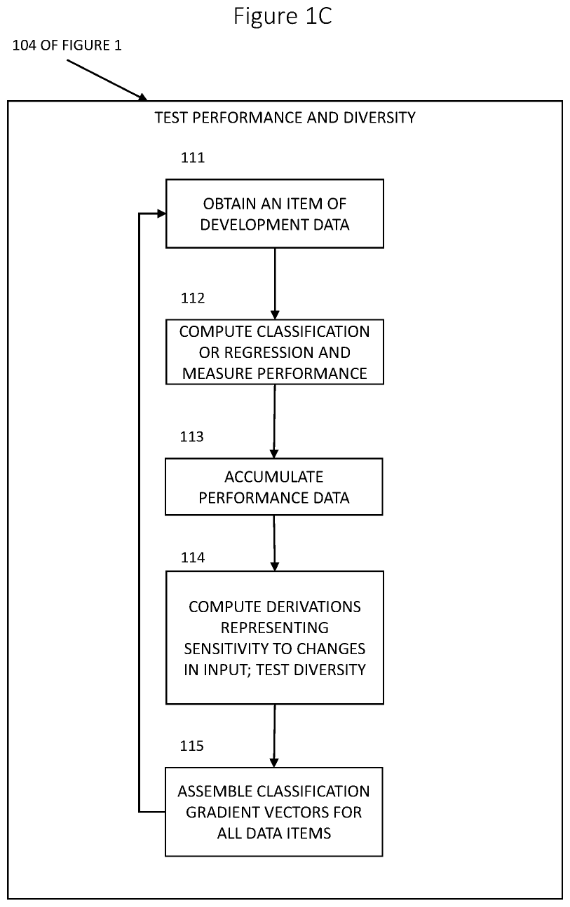

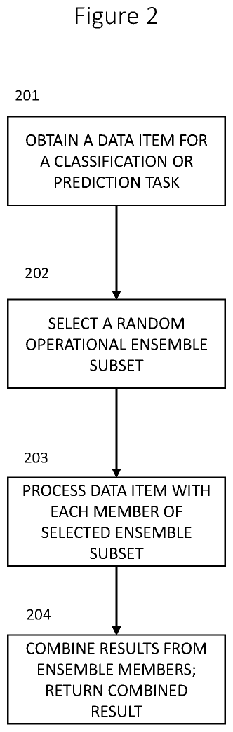

FIGS. 1 and 2 are flow charts illustrating embodiments of various aspects of the present invention.

FIG. 1A is a flowchart of an illustrative embodiment an aspect of the invention that is used in various embodiments.

FIG. 1B is an example of a vector of target values for a secondary objective used in some aspects of the invention.

FIG. 1C is a flowchart of an aspect of the invention that is an illustrative embodiment of an aspect of various embodiments illustrated in FIG. 1.

FIG. 3 is a diagram of a computer system that may be used to implement various embodiments of various aspects of the invention.

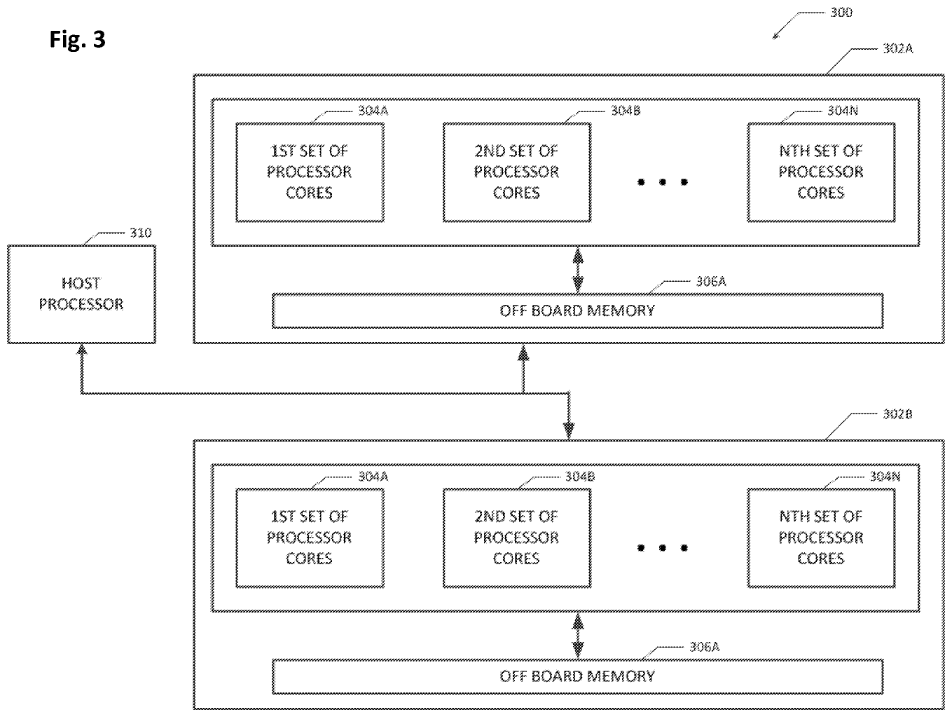

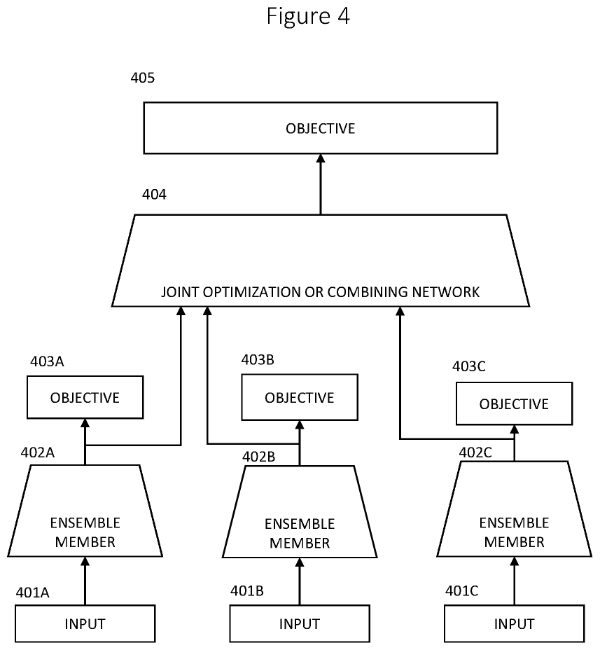

FIG. 4 is a block diagram of a system that combines the results of a plurality of machine learning system ensemble members and that optimizes a joint objective in various embodiments of the invention.

FIG. 5 is a diagram of an example deep neural network such as is used in various embodiments of the invention.

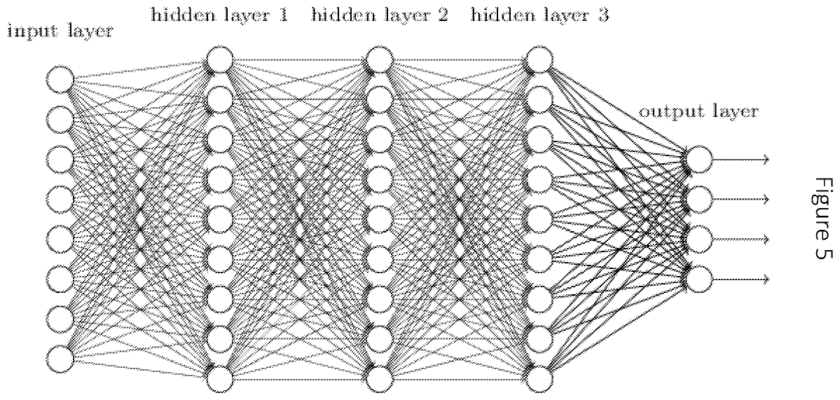

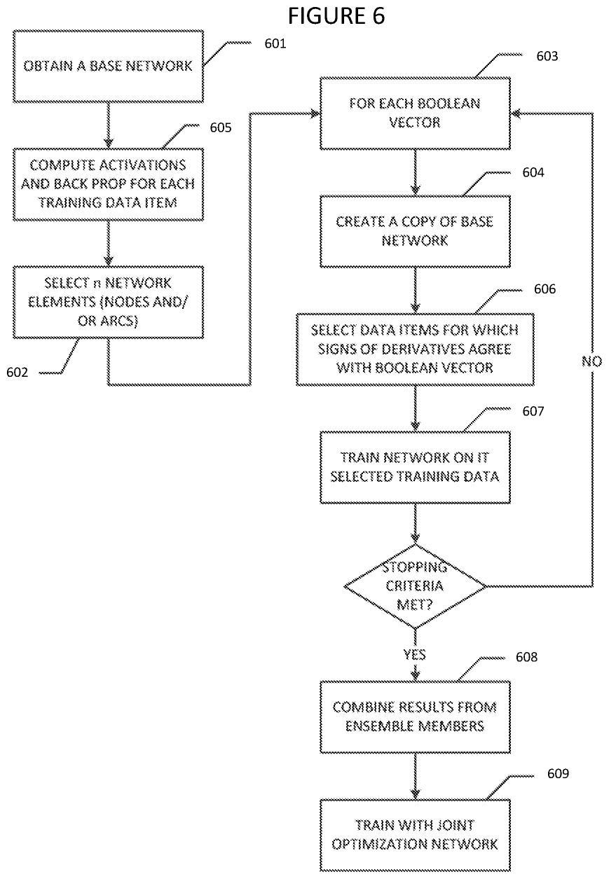

FIGS. 6 through 8 depict an embodiment of a technique referred to herein as “blasting” for training ensemble members for diversity.

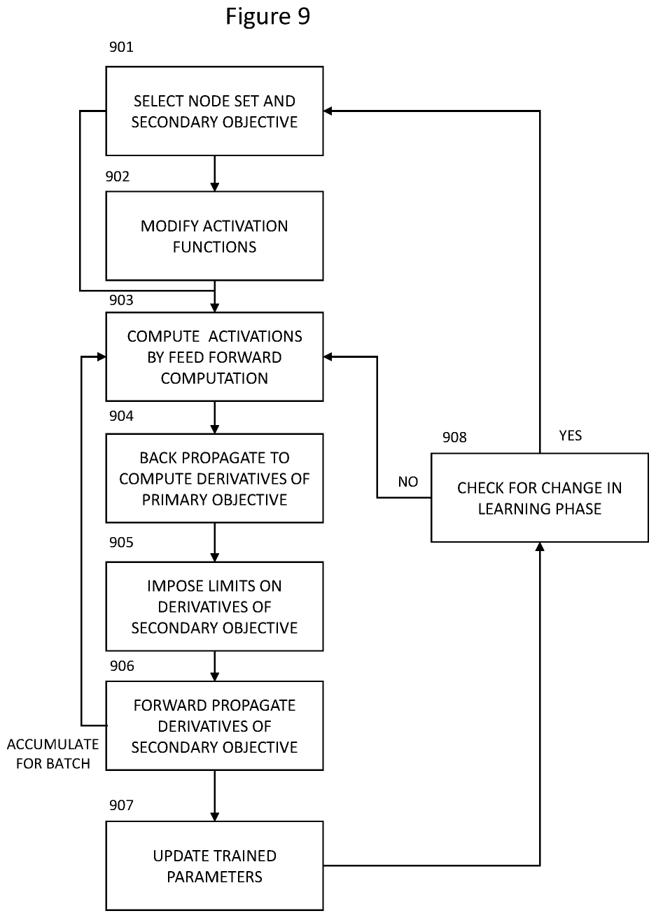

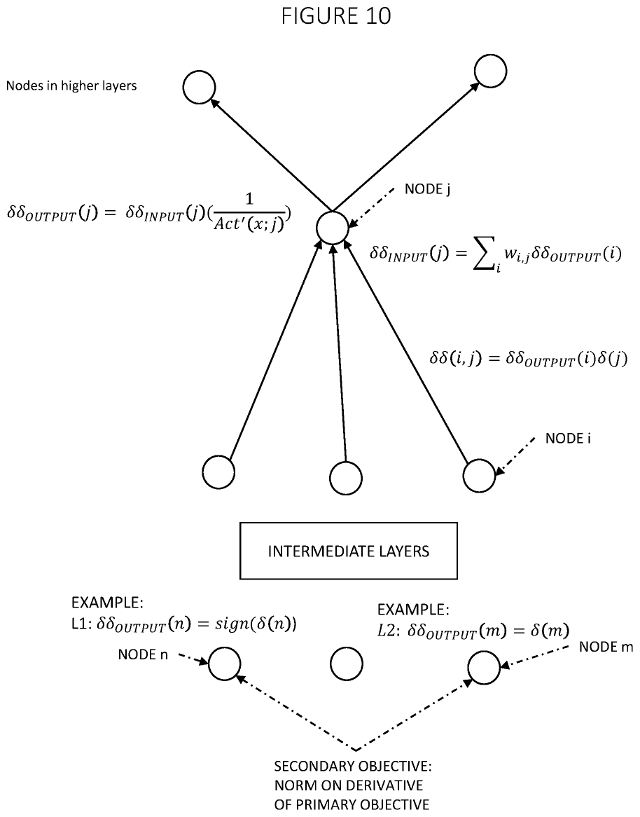

FIGS. 9 and 10 depict an embodiment for training a machine-learning network with primary and secondary objectives.

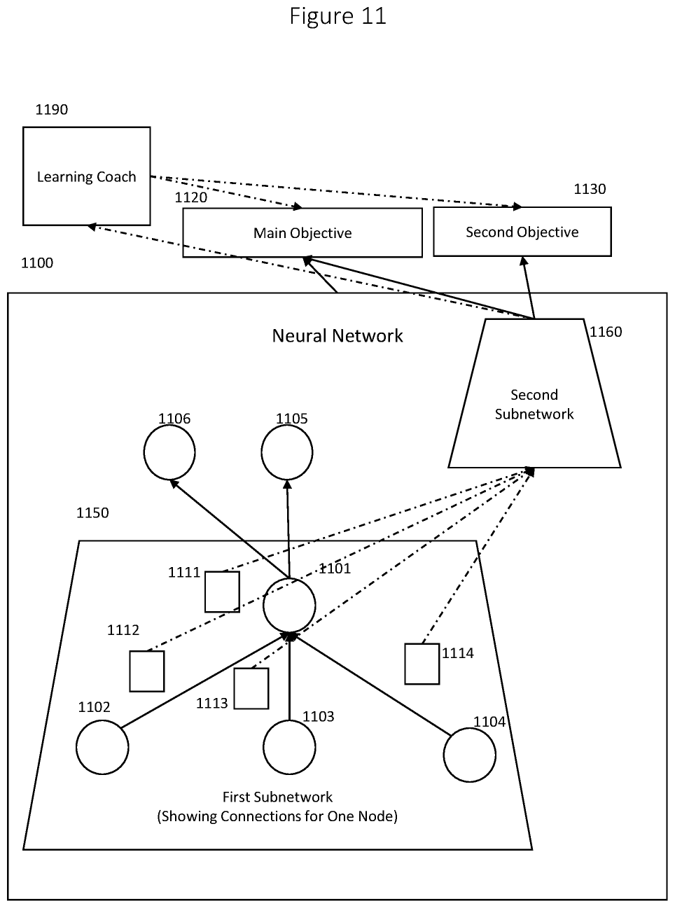

FIG. 11-13 depict an embodiment for improving a first deep neural network based on computations by a second deep neural network that uses a different objective than the first deep neural network and that uses as input values computed in the back-propagation computation for the first deep neural network that are computed using the first deep neural network's objective.

### DETAILED DESCRIPTION

FIG. 1 is a flowchart of an illustrative process according to various embodiments of the present invention in which a computer system, such as the one illustrated in FIG. 3, trains an ensemble of machine learning systems to be robust against adversarial examples. The machine learning systems may be deep neural networks, such as shown in FIG. 5, or they may be any other type of machine learning system. The machine learning systems that are members of the ensemble do not even need all to be the same type.

In step 101, the computer system obtains or trains a base ensemble of machine learning systems. The computer system may obtain the base ensemble by creating the base ensemble or receiving data about an ensemble created by another system. Any of many well-known methods for building and training ensembles of machine learning systems may be used in various embodiments of the invention to generate the base ensemble, such as many variations of bagging, boosting, pasting, and random forests.

Preferably, in step 101, the computer system uses an ensemble building method such as “blasting,” which creates an ensemble with many ensemble members that are trained on sets of training data, to build the base ensemble. In blasting, the training data subsets (which may be disjoint and/or unique) are selected to increase diversity among the ensemble members. This situation facilitates the ability of the computer system to do development testing and cross-validation of individual ensemble members as well as improving the joint performance of the ensemble. It also enables development testing and cross-validation of subsets of the set of ensemble members in step 104 and in FIG. 2. The technique of building an ensemble by blasting is described further below and in International patent application Serial No. PCT/US19/4033, filed Jul. 2, 2019, entitled “Building Ensembles for Deep Learning by Parallel Data Splitting”, which is incorporated herein by reference in its entirety.

In step 110, the computer system trains the ensemble members of the base ensemble to have diversity with regard to sensitivity to changes in input variables. In some embodiments, this diversity in input sensitivity is achieved by general purpose mechanisms for increasing diversity, such as differences in the training data used in training one ensemble member from another. In one illustrative embodiment, this diversity in input sensitivity is achieved by a selection process in which candidate ensemble members are selected based on their degree of diversity relative to previously selected ensemble members.

In a preferred embodiment, the computer system uses the process illustrated in FIG. 1A to train an ensemble member with a secondary objective in addition to the primary classification or regression objective. In preferred embodiments, this secondary objective trains a machine learning system to attempt to match a target input sensitivity value for each input variable for each training data item. That is, for example, the secondary objective is that the partial derivatives with respect to the first function match the desired target input sensitivity, although a perfect match is unlikely to be achieved and a matching that is within a threshold is acceptable.

In preferred embodiments, the methodology illustrated in FIG. 1A may be used to train an individual ensemble member in step 110 in FIG. 1, to jointly train a selected subset of ensemble members in step 103 in FIG. 1, and/or to further train a selected subset of ensemble members in step 114 of FIG. 1C. Since the methodology of FIG. 1A can be used in multiple steps of FIG. 1 and/or FIG. 1C, it will be discussed first before returning to the discussion of the remaining steps of FIG. 1.

In the aspect of the invention illustrated in FIG. 1A, the computer system measures the sensitivity of a machine learning system to a change in an input variable for a training data item by measuring the amount of change in a designated piecewise differentiable function of the vector of output values caused by a change in the value of an input variable. If the machine learning system is a neural network, this partial derivative may be computed by back propagation. In other cases, this partial derivative may be computed by numerical estimation. The computer system selects the piecewise differentiable function of the output in step 140. The computed or estimated partial derivatives with respect to the input are used as data for a secondary objective. The use of partial derivatives as data is described in more detail below and in International patent application Serial No. PCT/US19/35300, filed Jun. 4, 2019, entitled “USING BACK PROPAGATION COMPUTATION AS DATA,” (hereinafter the “Back Propagation PCT Application”) which is incorporated herein by reference in its entirety.

In the process illustrated in FIG. 1A, the computer system creates or enhances the diversity of ensemble members by having a secondary objective with a vector of target values for the estimated input sensitivities for each ensemble member. In a preferred embodiment, the target vector for the secondary objective takes a form such as shown in FIG. 1B. Preferably, the target vector is different for each ensemble member. Training for such a secondary objective in addition to the primary classification or regression objective is described in more detail below and in International patent application Serial No. PCT/US19/39703, filed Jun. 28, 2019, entitled “FORWARD PROPAGATION OF SECONDARY OBJECTIVE FOR DEEP LEARNING” (hereinafter “Forward Propagation of Secondary Objective PCT Application”), which is incorporated herein by reference in its entirety.

FIG. 1A illustrates a process for training the secondary objective as well as for computing or estimating the partial derivatives used in that objective. By way of illustration, the training process in FIG. 1A may be an iterative process based on stochastic gradient descent with the training data organized into minibatches with an update in the learned parameters for each minibatch. Stochastic gradient descent based on minibatch updates is well-known to those skilled in the art of machine learning. For example, stochastic gradient descent is commonly used for training neural networks.

In step 140, the computer system selects a single-valued piecewise differentiable function of the vector of output values for the machine learning system. The partial derivative of the single-valued differentiable function will represent the sensitivity of the output values with respect to the input values. The process illustrated in FIG. 1A optimizes a secondary objective of the diversity among the ensemble members with respect to this sensitivity to changes in the input values. This single-valued differentiable function is not in itself an objective to be optimized. Preferably, the selected single-valued differentiable function has the property that changes in the value of the selected function are indicative of changes in the output that are significant to the task of the machine learning system. A preferred example of a single-valued piecewise differentiable function is maximum of the output values. Another example is the difference between the maximum output value and the second largest output value. Another example is the difference between the output value for the correct category and the maximum output value for an incorrect answer.

Some preferred embodiments represent the sensitivity as a signed value rather than as a magnitude because a sensitivity of the same magnitude but of opposite sign is a significant diversity between two ensemble members. For such embodiments, a differentiable function such as the maximum of the output values is preferable to, say, the loss or error cost function for the primary objective of the machine learning task since the loss function does not distinguish between deviations from the target of equal magnitude but opposite sign. Preferably, the piecewise differentiable function selected in step 140 is the same each time the computer system executes the process of FIG. 1A for different ensemble members or different subsets of the ensemble.

The loop from step 122 to step 125 and back to step 122 represents the processing of one training data item. The loop from step 122 to step 127 and back to step 122 represents the processing of one minibatch. Of course, these loops may be repeated iteratively for each training data item and for each minibatch.

The loop from step 120 to step 127 by way of step 122 and eventually back to step 120 may represent the training of one ensemble member as in step 110 of FIG. 1 or the loop may represent the training of a subset of ensemble members as in step 103 of FIG. 1 or step 114 of FIG. 1C. Again, this loop may be repeated for each ensemble member at step 110 and/or step 103.

In step 120, the computer system controls the iterative training of an ensemble member or the joint training of a set of ensemble members. The joint training of a set of ensemble members may use a simple ensemble combining rule or may use a combining network or a joint optimization network, as illustrated in FIG. 4. More details about combining networks and joint optimization networks may be found in published International patent application WO/2019/067542 A1, published Apr. 4, 2019, entitled “Joint Optimization of Ensembles in Deep Learning” (hereinafter “Joint Optimization of Ensembles PCT Application”), which is incorporated herein by reference in its entirety.

In some embodiments, the target values for partial derivatives of the function selected in step 140 vary from one ensemble member or one subset of ensemble members to another but do not vary from one training data item to another. In these embodiments, in step 121, the computer system selects a target vector for the values of the partial derivatives of the function selected in step 140 with respect to the input values. In embodiments in which the target values vary from one training data item to another, this target selection is done in step 124.

An example target vector is shown in FIG. 1B. In either step 121 or step 124, the computer system selects a target vector for each ensemble member or for each selected subset of ensemble members such that the target vectors differ from each other. The differences in the target vectors create the desired diversity. The diversity is not directly measured as an objective, but it is used as an acceptance criterion in step 105 of FIG. 1. Preferably, the target vector for any two ensemble members or for any two selected subsets of an ensemble have a low correlation. In an illustrative embodiment, each value in the target vector is chosen from the set {−1, 0, 1} and the positions in the vector that receive values −1 and 1, respectively, are chosen at random with a statistically independent random selection for each ensemble member or for each selected subset of the ensemble. In FIG. 1B, the example target vector has values in the set {−1, 0, 1}. In a preferred embodiment, a target vector takes values from the set {−ε, 0, ε}, where ε is a hyperparameter that is tuned to optimize a trade-off between how well the training can match the target, which may be more difficult for small values of ε, against the magnitude of the norm of the vector of input sensitivities, for which smaller values of ε are desirable. For reasons of general robustness, it is desired that the norm of the vector of input sensitivities be small. In various embodiments other sets of possible values and other random or pseudo-random arrangements of those values may be used.

In step 122, the computer system computes the activation for the machine learning system or systems being trained for a training data item. The activation computation comprises at least computing the output values of the machine learning system. If the machine learning system is a neural network, in preferred embodiments this activation computation comprises a feed forward computation of the activation values of the nodes in the network.

In step 123, the computer system computes or estimates the partial derivative of the selected piecewise differentiable function of the output values with respect to an input variable. Preferably, in step 123, the computer system computes or estimates the partial derivative of the selected differentiable function with respect to each of the input values. If the machine learning system is a neural network, in preferred embodiments, in step 123, the computer system back propagates partial derivatives as in the well-known back propagation computation used in stochastic gradient descent training of a neural network, except in step 123 the computer system computes partial derivatives of the function selected in step 140 rather than partial derivatives of the loss function for the primary objective.

These partial derivatives are used as data for defining a secondary objective rather than for gradient descent training of the primary objective. Use of partial derivatives as data is described in more detail in the aforementioned and incorporated Back Propagation PCT Application.

Preferably, in parallel with step 123, the computer system also computes the partial derivative of the primary objective with respect to each learned parameter, for example by back propagation in the case of a neural network. This is the normal computation for stochastic gradient descent training of a machine learning system. It is well-known to those skilled in the art of training machine learning systems and is not shown explicitly in FIG. 1A.

In step 124, the computer system selects, as a secondary objective, a target vector for the vector of partial derivatives of the function selected in step 140. This selection is the same as the selection of the target vector described in association with step 121 except that, in step 124, the computer system may select a secondary objective target vector for a training data item that is different from the target vector selected for another training data item. This difference is not essential. The requirement is that the secondary objective target vectors for pairs of ensemble members or for pairs of selected subsets of the ensemble have low correlation, not that there always be a difference for different data items. Any number of training data items may have the same secondary objective target vector when training the same ensemble member or the same ensemble subset. In some embodiments, a different target vector is chosen for a data item in order to make it easy for a machine learning system to match the target.

In step 125, the computer system creates or selects a secondary objective such as a loss function based on the difference between the derivatives with respect to the input computed in step 123 and the target values for those derivatives set in step 121 or 124. The computer system then computes the derivatives of this secondary objective with respect to the learned parameters of the machine learning system. Since the secondary objective is itself a function of derivatives that are treated as data, these derivatives of the loss function of the secondary objective are referred to herein as “secondary derivatives” to distinguish them from the derivative of the primary objective. In the case in which the machine learning system is a neural network, these secondary derivatives are computed by applying the chain rule of calculus as in back propagation of derivatives of the primary objective. However, the secondary derivatives are computed by propagation in the opposite direction from the direction in which the secondary objective was computed. That is, the secondary derivatives are computed by forward propagation through the network.

In some embodiments, the forward activation computed in step 121, the back propagation computed in step 122, and the forward propagation of the secondary derivatives in step 124 are computed based on a neural network or networks with modified activation functions. Preferably, the original unmodified activation functions are used for computing the estimated gradient of the primary objective, and the computer system performs separate computations with the modified activation functions for steps 121, 122, 123, and 124.

In one aspect, a modified activation function may be used to make the sensitivity of the function selected in step 140 to changes in the input values more prominent and thereby to facilitate creating diversity with respect to that sensitivity among ensemble members. As an illustrative example of this aspect, an activation function may be smoothed or low-pass filtered. For example, an activation function may be convolved with a non-negative function that is symmetric about zero, such as

$$g ( x ) = exp ( - \frac{{x}^{2}}{T} ) ,$$

where T is a hyperparameter controlling the effective width of the convolution and hence the degree of smoothing. Smoothing spreads out the range of input values for which the effect of a change in the activation function affects the output. Modifying an activation function to make sensitivity to changes in the input more prominent is described in more detail in International patent application Serial No. PCT/US19/39383, filed Jun. 27, 2019, entitled “ANALYZING AND CORRECTING VULNERABILITIES IN NEURAL NETWORKS” (hereinafter “Correcting Vulnerabilities PCT Application”), which is incorporated herein by reference in its entirety.

In another aspect, a modified activation function may be used to facilitate the forward propagation of the partial derivatives of a secondary objective. For example, a linear term with a positive slope s>0 may be added to a monotonic activation function in order to bound the derivative of the activation function away from zero. Having the modified activation function be bounded away from zero facilitates the forward propagation because in some embodiments the computer system computes the partial derivative of the secondary objective with respect to the output of NODE j by the formula

$${δδ}_{OUTPUT} ( j ) = {δδ}_{INPUT} ( j ) ( \frac{1}{{Act}^{′} ( x ; j )} ) ,$$

where Act′(x;j) is the modified activation function for node j. However, some embodiments modify the forward propagation formula instead, for example by using the formula

$${δδ}_{OUTPUT} ( j ) = {δδ}_{INPUT} ( j ) min ( T , \frac{1}{{Act}^{′} ( x ; j )} ) ,$$

where T is a hyperparameter. Modifying an activation function in order to facilitate forward propagation of a secondary objective is described in more detail in the aforementioned and incorporated Forward Propagation of Secondary Objective PCT Application.

In an illustrative embodiment, the computer system repeats the loop from step 122 to step 125 for each training data item in a minibatch, as mentioned above.

In step 126, the computer system updates the learned parameters. In an illustrative embodiment, the computer system estimates the gradient of the primary objective based on back propagation of partial derivatives of the primary objective, with the estimated gradient accumulated over each training data item in a minibatch. In this illustrative embodiment, the computer system also estimates the gradient of the secondary objective by accumulating the estimates of the partial derivative computed in step 125. In an illustrative embodiment, the computer system then multiplies each of these to gradient estimates by its respective learning rate. The computer system adds these two weighted terms and any additional terms, such as regularization terms, to determine the incremental update that is to be made to each learned parameter.

In step 127, the computer system proceeds back to step 122 for the processing of another minibatch, as mentioned above, until a full epoch has been processed. The computer system repeats this process for multiple epochs until a stopping criterion is met. The stopping criterion, for example, may be that (1) the learning process has converged, (2) performance on a validation set has ceased to improve, or (3) a specified number of epochs have been processed.

When a stopping criterion is met in step 127, the computer system returns to step 120 to process another ensemble member or another subset of ensemble members. Once all ensemble members or all selected subsets of ensemble members have been processed, the computer system returns control to the step from which it was called, that is, step 110 or step 103 of FIG. 1 or to step 114 of FIG. 1C.

Returning to the discussion of FIG. 1, the base ensemble comprises multiple (N>1) different subsets of ensemble members. The subsets, as described below, comprise one or more ensemble members of the base ensemble, and the subsets need not comprise the same number of ensemble members. Also, the subsets could be disjoint from one another, although in other embodiments, subsets could overlap partially (e.g., a particular ensemble member of the base ensemble could be included in multiple subsets). At step 102, the computer system selects one of the N subset of the ensemble members for evaluation of whether it should be included in the final, operational ensemble. The subset may be selected by a systematic procedure or may be selected at random. For example, the computer system may select a random subset by sampling ensemble members one at a time without replacement with each ensemble member being equally likely to be selected.

In some preferred embodiments, each of the N subsets comprises a specified number of ensemble members of the base ensemble. For example, in one preferred embodiment, the number of ensemble members in the base ensemble is an even number, and each of the N subsets comprises a quantity of ensemble members that is equal to one-half the total number of ensemble members in the base ensemble.

For completeness of the discussion, in one example embodiment, each of the N subsets comprises has only a single member of the base ensemble. This embodiment is equivalent to selecting ensemble members rather than selecting ensemble subsets. Thus, the technique of selecting individual ensemble members in step 102 is just a special case of selecting ensemble subsets.

On the other hand, in one illustrative embodiment, given any base ensemble of machine learning systems, the computer system creates a powerset ensemble with a member in the powerset ensemble for each subset of ensemble members in the base ensemble. A member of the powerset ensemble is created by combining the output of the members of the subset of members in the base ensemble with a simple score combining rule, such as the arithmetic mean or the geometric mean, or by using a combining network or a joint optimization network as illustrated in FIG. 4. This embodiment illustrates that, in training or in operation, any process that can be done with subsets of an ensemble, the base ensemble, can be done as a process using single members of another ensemble, the powerset ensemble. Therefore, from a technical perspective, either using single ensemble members or using subsets of ensemble members is a generalization of the other. Without limiting the scope of the invention, the discussion will continue to be in terms of selecting subsets of ensembles in step 102, although it should be recognized that the present invention is not so limited as just explained. In an illustrative embodiment, the process of FIG. 1A is used to train individual ensemble members to match an input sensitivity target in step 110, optionally to include joint training of a subset of ensemble members to an input sensitivity target in step 103, and optionally to include further joint training of a subset of ensemble members to achieve a diversity criterion in step 104, as detailed in step 114 of FIG. 1C.

In general, the performance of an ensemble improves as the number of ensemble members is increased. Often, however, beyond some number of ensemble members there is little further improvement. The number of ensemble members at which there is little further improvement varies depending on the application and on the ensemble building method that is used. However, in many cases for a given application and ensemble building method, the number of ensemble members at which there is lack of significant further improvement is comparable for different random selections of the ensemble members. In such a case, in a preferred embodiment, the computer system in step 101 obtains a base ensemble for which the number of ensemble members is a specified multiple of the number of ensemble members for which there is no significant further improvement. Then, in step 102, in this preferred embodiment, the computer system specifies in step 102 that the number of ensemble members in a selected subset be equal to or slightly greater than the number at which there is generally no significant further improvement in the performance of an ensemble with that number of members.

The criterion for what constitutes “significant improvement” may be determined by the system developer or perhaps by a learning coach. For example, the performance level beyond which no significant further improvement is expected may be set at a percentage, say 95, 98, or 99 percent, of the best performance that has been observed in previous systems developed for the same problem or in previous experiments with the current system.

The learning coach can be a second, separate machine learning system that is trained to help manage the learning process of a first machine learning system, in this case, for example, the machine learning ensemble that is trained pursuant to the process of FIG. 1. That is, the learning coach is not trained to perform the same classifications as the ensemble trained pursuant to the process of FIG. 1, but instead the learning coach is trained to help manage the learning process for that ensemble, such as by determining the appropriate level for significant improvement or other hyperparameters. Learning coaches are described in more detail in the following published International patent applications, which are incorporated herein by reference in their entirety: WO/2018/063840, published Apr. 5, 2018, entitled “LEARNING COACH FOR MACHINE LEARNING SYSTEM”; and WO/2018/175098 A1, published Sep. 27, 2018, entitled “LEARNING COACH FOR MACHINE LEARNING SYSTEM”.

In some embodiments, the computer system trains each ensemble member on a disjoint set and also limits the maximum number of ensemble members in a selected subset. These embodiments facilitate cross-validation and cross-development using training data of ensemble members that are in the complement set of the selected subset.

The computer system executes the loop from step 102 to step 106 multiple times (J≥2 times) to select J sets of the N subsets of the base ensemble, where J≤N, and then tests each selected subset for performance and diversity, as described below. Based on the tests, the computer system accepts a set of P>1 tested subsets as operational ensemble subsets to be included in the operational ensemble such that each accepted operational subset of the operational ensemble meets a performance objective and such that, collectively, the set of accepted operational ensemble subsets have diverse responses to adversarial attacks.

One illustrative embodiment does not use steps 103 to 106 but instead includes every ensemble subset selected in step 102 in the set of operational ensemble subsets (i.e., P=J). Preferably, in this illustrative embodiment, step 102 imposes a constraint on the ensemble subsets selected in step 102. For example, in this illustrative embodiment, the computer system may impose the constraint that each ensemble subset selected in step 102 has at least K members. Preferably, K is a hyperparameter such that it is expected that any ensemble subset with at least K members will have adequate performance. This illustrative embodiment relies on the diversity that occurs naturally among a set of randomly selected ensemble subsets.

In other embodiments, the computer system performs the steps from 102 to 106 to test individual ensemble subsets selected by step 102.

Step 103 is optional, as indicated by the dashed line around block 103 and the dashed line arrows from steps 102 to 103 and from steps 103 to 104, as opposed to the solid line arrow from step 102 to step 104. Other steps in FIG. 1 could also be optional, and therefore omitted, in other embodiments.

In step 103, if employed, the computer system adds a joint optimization or combining network 404 to the set of ensemble members selected at step 102, as shown in FIG. 4. The combining network 404 may be a neural network, such as the example shown in FIG. 5. The combining network may be initialized to emulate any well-known ensemble-member-averaging or voting computation. The input data vector of network 404 is the concatenation of the output vectors of the ensemble members. The combining network may be trained by any well-known neural network training method, such as stochastic gradient descent with parameter updates computed for every minibatch of training data items based on estimates of the gradient computed by back propagation of partial derivatives backwards through combining network 404.

In some embodiments, in step 103, the computer system computes a joint optimization with a secondary objective of diversity as discussed in association with FIG. 1A. In these embodiments, the computer system computes a joint optimization of the subset of ensemble members selected in step 102 that comprises a secondary objective with a diverse set of target vectors for the derivatives with respect to the input such as discussed for individual ensemble members in association with step 110 as well as comprising the primary objective. In some embodiments, the optimization of a secondary diversity objective is performed in step 114 of FIG. 1C and not in step 103. In some embodiments, the optimization of a secondary objective is performed both in step 103 and in step 114.

In some embodiments, the joint optimization computation in step 103 optimizes only the combining network 404 in FIG. 4. For example, such an embodiment may be used if the joint optimization network is a neural network, but the ensemble members are machine learning systems that are not trained by back propagation. In some embodiments, the joint optimization computation in step 103 of the subset of ensemble members selected in step 102 comprises optimization of the members of the selected subset such as 402A, 402B, and 402C in FIG. 4.

If the ensemble members are also neural networks or some other type of machine learning system that can be trained by back propagation of partial derivatives, then the partial derivatives computed by back propagation through the combining network may be (i) further back propagated to the input vector for combining network 404, (ii) added to the back propagation from each ensemble member's individual objective cost function, and (iii) then back propagated backwards through each ensemble member for updating the parameters of each ensemble member. Thus, each ensemble member is trained to optimize the joint performance of the set of ensemble members rather than just its individual performance.

If the back propagation proceeds only through network 404 and not through the ensemble member systems, then network 404 is referred to herein as a “combining network.” If the back propagation proceeds through and trains the ensemble member systems, then network 404 is referred to herein as a “joint optimization network.” Any joint optimization network is also a combining network.

Returning back to FIG. 1, in step 104, the computer system measures the performance of the ensemble subset selected in step 102 and measures the degree of diversity of the ensemble subset selected in step 102 relative to other ensemble subsets previously selected in step 102. That is, for the first (j=1) iteration through the loop, the computer system computes the performance measure for the j=1 subset. Then for iterations j=2 to J, the computer system computes the performance measure for the j-th subset and measures the degree of diversity of the j-th subset to each of the j=1, . . . , j−1 subsets. A more detailed illustrative embodiment of the testing and measurement process of step 104 is illustrated in FIG. 1C.

Based on the testing in step 104, in step 105, the computer system accepts or rejects the current ensemble subset selected in step 102 (the jth subset) to be a member of a set of operational ensemble subsets that form or otherwise make up the final, operational ensemble that is robust to adversarial attacks. If the current ensemble subset is accepted, control proceeds to step 106, where the computer system adds the current ensemble subset (the jth subset) into the set of operational ensemble subsets. From step 106, the process returns to step 102 for consideration of the next selected subset unless a stop criterion is met. Similarly, if the current ensemble subset is not accepted (i.e., it is rejected) at step 105, control returns to step 102 until the stopping criterion is met. For example, the process may be stopped if a specified number, J, of ensemble subsets have been accepted as operational ensemble subsets or if all ensemble subsets have been tested. Preferably, J is greater than or equal to two, but less than or equal to N (the number of subsets selected at step 102).

FIG. 1C shows an illustrative embodiment of the details in step 104 of FIG. 1. The context of the process shown in FIG. 1C is that in step 102 of FIG. 1 the computer system has selected a subset of ensemble members. In an illustrative embodiment, the computer system applies the process of FIG. 1C to test the performance of the selected subset of the ensemble and to compute statistics relating to the correlation of the vulnerability of the selected subset to the vulnerabilities of the ensemble subsets that have already been put in the set of operational ensemble subsets.

In preferred embodiments, some data items are set aside for validation and for development. Validation data items and development data items are not used as training data items. In some preferred embodiments, one-half or more of the data is set aside as development and validation data. In addition, in some preferred embodiments, in step 101 of FIG. 1, the computer system builds or obtains an ensemble built by a technique such as blasting which creates many disjoint sets of data items as the training sets for the ensemble members. Thus, for any subset of ensemble members, the training data for the complementary subset of ensemble members may be used for cross-validation and cross-development.

As a guideline, the number of members in each selected subset should be large enough so that the performance of the ensemble subset is comparable to the performance of the full ensemble and the complementary subset should be large enough so that the disjoint training data used only for training the complementary subset is adequate for the desired amount of cross-development and cross-validation. Together these guidelines suggest that number of members in the ensemble be at least twice the number of members to reach the condition in which adding additional ensemble members does not significantly further improve performance on the primary objective. In some embodiments, the number of ensemble members may be significantly larger in order to facilitate the secondary objective of additional diversity of the sensitivity with respect to changes in the input.

The terms “development testing” and “cross-development” are not standardized terminology in machine learning. Some references do not distinguish between development testing and validation testing. Some references use training data for what is here considered development testing. These terms are used herein to refer to a form of testing and development that is intermediate between training and final testing for validation. For both development testing and validation testing it is preferred to use data items that have not been used in training, so that the test will reliably predict performance on new, unseen data. A data item may be used as a cross-development data item if it has not been used in training the system or ensemble member that is being tested. A cross-development data item may have been used in training some other system or ensemble member.

However, even if a data item has not been used for training, repeated testing using the same set of test data items may cause a trained model indirectly to adapt to the test data. On the other hand, development work may require experimentation and exploration of the system design space and therefore need repeated testing. The separation of development testing from validation testing allows the validation testing data to be set aside not only from training data, but also from development data.

In some preferred embodiments, there are multiple disjoint sets of development data and at least two disjoint sets of validation data. A development set may be used multiple times to make decisions during the development process, perhaps under the automated control of a learning coach. The first set of validation data is used to test a development set to verify that performance measurement of the development set is still predictive of the performance on new data. As soon as a development set is rejected by a test on the first validation set, the rejected development set is never used again, thus preventing the system from adapting to the first validation set. The test and rejection by the first validation set also stops further adaptation of the system to the rejected development set. The process of coordinated development testing and validation testing may be managed by a learning coach.

In step 111 of FIG. 1C, the computer system obtains a data item, which will be used for testing the performance of the subset of ensemble members selected in step 102 of FIG. 1. In preferred embodiments, each data item obtained by step 111 is an item of development data or cross-development data.

In step 112, the computer system computes the value of the objective of the output of the ensemble subset selected in step 102 of FIG. 1 for the data item obtained in step 111. The output for the ensemble subset selected in step 102 may be obtained by a combining rule or by a combining network or by a joint optimization network trained in step 103. If the ensemble members are neural networks, this computation of the value of the objective is an instance of feed forward activation, comprising feed forward activation of the member networks as well as feed forward activation of the combining network. Feed forward activation is well-known to those skilled in the art of deep learning.

In step 113, the computer system accumulates the performance data obtained for all the data items selected in step 111. The accumulated performance data is used in the accept versus reject decision in step 105 of FIG. 1.

In step 114, the computer system computes a measure of the diversity of input sensitivity of the members of the subset selected in step 102 of FIG. 1 by performing steps 121 through 125 for FIG. 1A, having done the same computation for each operational ensemble subsets accepted in step 105 of FIG. 1. Preferably, in step 140 of FIG. 1A, the computer system selects the same piecewise differentiable function of the output of the current subset selected in step 102 of FIG. 1 and for each of the previously accepted operational ensemble subsets. In an illustrative embodiment, the computer system computes the correlation of the vector of partial derivatives of the function selected in step 140 with respect to the input vector for the current selected subset with the vector of input derivatives for each of the previously accepted operational subsets. A characterization of these correlation values, such as a norm, will be used as a measure of diversity for the acceptance test in step 105 of FIG. 1.

Optionally, especially if the measure of diversity is unsatisfactory, in step 114 of FIG. 1C, the computer system retrains the ensemble selected in step 102 using the iterative training procedure of FIG. 1A. In various embodiments, this retraining may be done jointly on the ensemble subset as a whole or individually on selected members of the ensemble. Preferably, an individual member of the ensemble is not retrained if it has already been used as a member of a previously accepted operational ensemble subset. Preferably, in joint training of the ensemble subset, only the combining network and ensemble members that have not been used as members of previously selected operational ensemble subset, if there are any, are updated.

In some embodiments, each ensemble member is trained directly or indirectly to have low magnitude input derivatives. In some embodiments, for example, this property will be a natural consequence of training for robustness, such as by using the procedures described in published International patent application WO/2018/231708 A2, published Dec. 20, 2018, entitled “ROBUST ANTI-ADVERSARIAL MACHINE LEARNING,” which is incorporated herein by reference in its entirety. In some embodiments, this property will be a consequence of minimizing a related secondary objective as described in the aforementioned and incorporated Correcting Vulnerabilities PCT Application. In some embodiments, it will be a direct consequence of optimizing a secondary objective on input derivatives as in FIG. 1A for an individual member of the ensemble even without joint training of a secondary objective in step 103 of FIG. 1 or step 114 of FIG. 1C.

In some tasks the input derivatives have low magnitudes either naturally occurring or caused by the training procedures such as those mentioned in the previous paragraph. When the magnitude of a signed input derivative is close to zero, natural variation among ensemble members is likely to change its sign. This phenomenon may cause a low correlation for pairs of subsets of ensemble members even without training the ensemble subset for such a secondary objective as illustrated in FIG. 1A. In some embodiments, in step 114, the computer system merely accepts an ensemble subset that has a low correlation with previously accepted operational ensemble subsets without training for a secondary objective using the procedure of FIG. 1A. In one illustrative embodiment, the secondary objective of FIG. 1A is not used and the diversity among accepted operational ensemble subsets is obtained solely by the diversity testing process in step 114 and the accept/reject process of step 105 of FIG. 1.

The vector of partial derivatives of the differentiable function selected in step 140 of FIG. 1A with respect to the vector of input values is herein called the “classification gradient” for the data item selected in step 111. In step 115, the computer system assembles the classification gradient vectors for all the individual data items selected in step 111 into a single concatenated vector for diversity testing in step 105 of FIG. 1. The loop from step 111 to step 115 is repeated until all designated data items have been processed or some other stopping criterion is met. The procedure of FIG. 1C is then completed, representing one instance of step 104 of FIG. 1. The computer system then proceeds to step 105 in FIG. 1.

In step 105 of FIG. 1, the computer system may make two kinds of tests for each ensemble subset selected in step 102 of the ensemble selected in step 101 to determine whether each subset should be included in the operational ensemble: a performance test and a diversity test. In various embodiments, each subset, other than the first subset, has to pass both tests to be included in the final operational ensemble. In various embodiment, the first subset that passes the performance test can be included in the operational ensemble. Preferably, the number of subsets, P, accepted at step 105 for inclusion in the operational ensemble is greater than or equal to two, and less than or equal to J (where J is less than or equal to N).

In an illustrative embodiment, the performance test compares the accumulated performance measurement from step 113 of FIG. 1C with a specified minimum acceptable performance. This minimum acceptable performance may be specified by the system designer or by a learning coach. In an illustrative embodiment it is determined by a null hypothesis test at a specified level of significance. In this embodiment, the computer system measures the performance of the ensemble subset selected in step 102, preferably on a set of data that is disjoint from any of the data used to train the ensemble subset or any of its members. In this embodiment, before testing any selected ensemble subsets, the computer system first measures the performance of a set of random subsets of the ensemble, preferably ensemble subsets of comparable size to a subset to be selected in step 102. The computer system then estimates sufficient statistics for a parametric model of the probability distribution for the number of errors. For example, if the error rate is small, a Poisson distribution may be used. Then, for an ensemble subset selected in step 102 and tested in step 104, the computer system performs the one-sided null hypothesis test that the selected ensemble subset performs at least as well as the average performance for ensemble subsets of that size. The ensemble subset selected in step 102 passes the performance test unless the null hypothesis is rejected at the specified level of significance. If the size of each ensemble subset selected in step 102 is large enough that adding additional ensemble members does not significantly improve performance, then the distribution of performance on a randomly selected development test set will be predictable and most ensemble subsets selected in step 102 will pass the null hypothesis test.

Diversity among the members of an ensemble improves the ensemble performance on the primary objective. This type of diversity is herein called “normal diversity.” It is assumed that the design and training of the ensemble members have employed whatever techniques are desired to enhance normal diversity and that the effect of that diversity is already reflected in the measured performance of an ensemble subset selected in step 102. In step 105, the computer system tests diversity of the sensitivity to changes in the input (the classification gradient) as measured by step 123 of FIG. 1A and step 114 of FIG. 1C as part of step 104 of FIG. 1, which is quite different from and in addition to normal diversity as defined here.

It is also assumed that the computer system has already employed any desired techniques for improving the robustness of each ensemble member and of each jointly optimized ensemble subset. Such robustness enhancement techniques are herein called “normal robustness.” The term normal robustness includes optimization of a secondary objective minimizing the norm of the derivatives of a function of the output with respected the input values but does not include optimizing a secondary objective that measures the difference of a classification gradient and a target vector, where the target vector varies from one ensemble subset to another as in steps 124 and 125 of FIG. 1A and step 114 of FIG. 1C.

As is discussed in more detail in association with FIG. 2 below, in operational use a preferred embodiment of a “von Neumann ensemble” randomly selects which ensemble subset is to be used for each presentation of an item of operational data. This random selection causes the sensitivity to changes in the input to vary randomly in a manner that an adversary cannot predict. The input sensitivity diversity test applied by the computer system in step 105 increases the difficulty for an adversary attempting to predict the input sensitivity of the machine learning system.

In an illustrative embodiment, in step 105 of FIG. 1, the computer system tests the correlations of the classification gradient for the current ensemble subset selected in step 102 (i.e., the j-th subset) with classification gradients for previously accepted operational ensemble subsets (i.e., the subsets for j=1 to j−1 that were accepted previously at step 105). For example, in step 105, the computer system may reject an ensemble subset if the maximum magnitude correlation of the classification gradient of the ensemble subset with any of the previously accepted operational ensemble subset exceeds a specified value. In some embodiments, this maximum is computed as the worst-case maximum for the correlation computed separately for each training data item.

Preferably, an ensemble member selected in step 102 is accepted as an operational ensemble subset if it is accepted by both the performance test and the classification gradient diversity test in step 105. Preferably, the ensemble member selected in step 102 is rejected if it is rejected by either the performance test or the classification gradient diversity test.

If less than a desired number of ensemble subsets have been selected when some other stopping criterion is met, various embodiments may take remedial action. For example, one illustrative embodiment starts the process over with a larger base ensemble built or obtained in step 101. Another illustrative embodiment relaxes the acceptance criteria applied at step 105.

In step 106, the computer system records in memory a description of the ensemble subset that has been accepted in step 105 and any associated combining network or joint optimization network, and the computer system adds these descriptions to a set of operational ensemble subsets to be used in operation as illustrated in FIG. 2.

FIG. 2 is a flow chart of the use in operation of the operational ensemble comprising the set of P subsets accepted in step 105 of FIG. 1 and recorded in step 106. The context of FIG. 2 is that a set of ensemble subsets has been created, trained, and accepted as described in association with FIGS. 1 and 1C, or has been otherwise obtained.

The computer system used in operational use of the invention may be a different computer system from the computer system used in implementing FIGS. 1 and 1C. However, the computer system illustrated in FIG. 3 is an illustrative embodiment of the type of computer system that may be used either in operation of the invention as illustrated in FIG. 2 or in the processes illustrated in FIGS. 1 and 1C.

In step 201, the computer system obtains a data item for the operational task. The operational task may be either a classification task or a prediction task. A prediction task may also be called a regression task.

In step 202, the computer system randomly selects one of the operational ensemble subsets from the set of P operational ensemble subsets included in the final ensemble at step 106 of FIG. 1. In a preferred embodiment, for each presentation of an item of operational data, a new random selection is made of the operational ensemble subset to be used. Within the scope of the invention the random selection of the operational ensemble subset may be made less frequently than for every presentation of an item of operational data. However, the greatest robustness against adversarial attacks is achieved by performing a new random selection of the operational ensemble subset as frequently as practical, preferably for each item of operational data, especially if it is detected that the same data item is presented more than once.

In step 203, the computer system processes the operational data item obtained in step 201 with each ensemble member in the accepted operational ensemble subset selected in step 202. That is, if the task is a classification task, then in step 203, the computer system performs a classification of the operational data item obtained in step 201 for each member of the selected operational ensemble subset. If the task is a regression or prediction task, then the computer system computes a regression value or prediction for each member of the selected operational ensemble subset.

In step 204, the computer system combines the results from the members of the selected operational ensemble subset. The combination of results may be done by any of many combining rules that are well-known to those skilled in the art of using ensembles in machine learning. In some embodiments, the combining of results from the members of the selected operational ensemble subset is done by a combining network or by a joint optimization network, such as described in association with step 103 of FIG. 1 and illustrated in FIG. 4. Preferably, the combination method used in operation is the same as the combination method used during training and development.

In the operation illustrated in FIG. 2, it is assumed that an adversary may know or may guess the number of members of an ensemble and the architecture of each ensemble member. It is assumed that an adversary may even know the values of the learned parameters for each ensemble member and for a combining network or joint optimization network.

The mathematical field that studies adversarial situations is called the “theory of games.” In the mathematical theory of games, each player chooses a strategy and the outcome or value of the game is determined by the respective strategies of the players. In the foundational work on the mathematical theory of games, by John von Neumann and Oscar Morgenstern, the concepts of a “pure strategy” and of a “mixed strategy” are defined. A mixed strategy uses a random choice of a pure strategy. In repeated plays of even a very simple game, a player may do very poorly repeatedly using the same pure strategy without random variation, as in a mixed strategy. For example, in the children's game of “rock, paper, scissors” a player who always chooses “paper” will consistently lose once the other player learns to choose “scissors.” However, von Neumann proved that in any finite two-person zero-sum game there is always an optimum probabilistic mixed strategy that avoids this problem. That is, even if the pure strategies used in the mixed strategy are known and even if the mixture probabilities are known, the other player can do no better than to also use an optimum mixed strategy without regard to the knowledge of the first player's mixed strategy.

The operational ensemble subsets are not mathematically equivalent to pure strategies in the mathematical theory of games, and the random selection of an operational ensemble subset in step 202 is in no sense an optimum mixed strategy. However, this random selection of an operational ensemble subset presents the same difficulties to an adversary as does a mixed strategy in game theory and has additional advantages. For example, one form of adversarial attack in image recognition is to change each pixel in an image by a small amount in the direction of the sign of the classification objective with respect to the input variable that represents the pixel. However, due to the diversity acceptance criterion, an adversarial change based on the classification gradient for one operational ensemble subset will do little better than a random perturbation against another operational ensemble subset. In preferred embodiments, training each ensemble member using data augmentation with random perturbations makes the system robust against such random perturbations and therefore robust against adversarial attacks developed against an operational ensemble subset that is not the operational ensemble subset being used for the current data item. An ensemble of machine learning systems with random selection of operational ensemble subsets, e.g., the result of the process of FIG. 1, is herein called a “von Neumann ensemble.”

In another type of adversarial attack, an adversarial attack is developed by trying very many adversarial attacks at random and choosing the ones that work best against a given data example. This form of adversarial attack fails against a von Neumann ensemble for several reasons. First the information gathering process fails because there will be no consistency in the difference in degree of success for two instances of an adversarial attack because with high probability any two instances of an adversarial attack will be against two different random selections of an operational ensemble subset. In addition, even if by pure chance an adversarial attack made during the exploration process achieves some level of success, that same adversarial attack used in later operation would do no better than a random perturbation for the same reason as in the previous paragraph. In addition, the large number of exploratory attacks that are needed because of the apparent inconsistency of the observed behavior of the system being attacked would facilitate the ability of defensive measures to detect the adversarial attack and to take counter measures.

Although in preferred embodiments there is an independent random selection of the operational ensemble subset to use for each operational data item, that preferred non-deterministic property is not essential. In a simple illustrative embodiment, the selection of the operational ensemble subset is done by a hash function of the input vector. In this embodiment, the response to any input will be deterministic in the sense that any two presentations of exactly the same input data will generate exactly the same response. However, to an adversary the responses to a sequence of varying input will appear just as random as in the random von Neumann ensemble. This simple illustrative embodiment may still be vulnerable to some forms of adversarial attack.

In a more complex illustrative embodiment, each member of the ensemble and/or each jointly optimized operational ensemble subset continues adaptive training during operation. This form of adaptive training is also called “life-long” learning and is discussed in published International patent application WO/2018/226492 A1, published Dec. 13, 2018, entitled “ASYNCHRONOUS AGENTS WITH LEARNING COACHES AND STRUCTURALLY MODIFYING DEEP NEURAL NETWORKS WITHOUT PERFORMANCE DEGRADATION,” which is incorporated herein by reference in its entirety. Depending on the application and the type of interaction with the user, the adaptive training may be supervised, partially supervised (that is, supervised by inference from user's actions), implicitly supervised (if the user implicitly confirms an answer by making no correction when there is an opportunity to do so), semi-supervised (by assuming that the classification of new, unseen data is correct), or any other form of adaptive training. In some embodiments, the learning rate for the training may be conservative, that is, its value may be very small, especially for situations in which the adaptive training is not fully supervised. Preferably, the learning rate is never zero.

In this illustrative embodiment, each operational data item is first processed by a special network which has been subjected to adaptive training. For example, this special network may be a subnetwork of one of the ensemble members. The selection of the operational ensemble member to use for this operational data item is then determined by a hash function based on a set of node activations within the special network. This embodiment is technically deterministic in the sense that between adaptive training updates there is no change in the output computed for any fixed input. However, with continual adaptive updates for every operational data item, the behavior of the system from the perspective of an adversary is indistinguishable from the behavior of a random von Neumann ensemble.

FIG. 3 is a diagram of a computer system 300 that could be used to implement the embodiments described above, such as the process described in FIGS. 1, 1A, 1C and 2. The illustrated computer system 300 comprises multiple processor units 302A-B that each comprises, in the illustrated embodiment, multiple (N) sets of processor cores 304A-N. Each processor unit 302A-B may comprise on-board memory (ROM or RAM) (not shown) and off-board memory 306A-B. The on-board memory may comprise primary, volatile and/or non-volatile, storage (e.g., storage directly accessible by the processor cores 304A-N). The off-board memory 306A-B may comprise secondary, non-volatile storage (e.g., storage that is not directly accessible by the processor cores 304A-N), such as ROM, HDDs, SSD, flash, etc. The processor cores 304A-N may be CPU cores, GPU cores and/or AI accelerator cores. GPU cores operate in parallel (e.g., a general-purpose GPU (GPGPU) pipeline) and, hence, can typically process data more efficiently that a collection of CPU cores, but all the cores of a GPU execute the same code at one time. AI accelerators are a class of microprocessor designed to accelerate artificial neural networks. They typically are employed as a co-processor in a device with a host CPU 310 as well. An AI accelerator typically has tens of thousands of matrix multiplier units that operate at lower precision than a CPU core, such as 8-bit precision in an AI accelerator versus 64-bit precision in a CPU core.

In various embodiments, the different processor cores 304 may train and/or implement different networks or subnetworks or components. For example, in one embodiment, the cores of the first processor unit 302A may train the von Neumann ensemble and the second processor unit 302B may implement the learning coach. For example, the cores of the first processor unit 302A may train the von Neumann ensemble members and perform the processes described in connection with FIGS. 1, 1A and 1C, whereas the cores of the second processor unit 302B may learn, from implementation of the learning coach, relevant hyperparameters for the von Neumann ensemble members. Further, different sets of cores in the first processor unit 302A may be responsible for different ensemble members of the von Neumann ensemble. Also, yet another processor unit could implement and train the joint optimization or combining network described in connection with FIG. 4. In another embodiment, a separate set of processor cores of one of the processor units 302A, 302B could implement and train the joint optimization or combining network described in connection with FIG. 4. One or more host processors 310 may coordinate and control the processor units 302A-B.

In other embodiments, the system 300 could be implemented with one processor unit 302. In embodiments where there are multiple processor units, the processor units could be co-located or distributed. For example, the processor units 302 may be interconnected by data networks, such as a LAN, WAN, the Internet, etc., using suitable wired and/or wireless data communication links. Data may be shared between the various processing units 302 using suitable data links, such as data buses (preferably high-speed data buses) or network links (e.g., Ethernet).

The software for the various compute systems described herein and other computer functions described herein may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C #, COBOL, Fortran, Java, Lisp, Pascal, Object Pascal, Haskell, ML; and examples of scripting languages include Bourne script, JavaScript, Python, Ruby, Lua, PHP, and Perl.

FIG. 4 is a block diagram of a system in which a neural network is used to combine the results of the members of an ensemble or of the members of a subset of an ensemble, as in various embodiments described above. In the terminology herein, the neural network 404 is called a combining network. In preferred embodiments, network 404 is trained by stochastic gradient descent using a back propagation computation to compute the partial derivatives of objective 405 with respect to elements of network 404. Such a back propagation computation is well-known to those skilled in the art of training neural networks.

Each ensemble member 402A, 402B, or 402C receives its respective input 401A-C. Each of the input data vectors 401A, 401B, and 401C may be the same as the others for a given input data item, or they may be different. For example, although no difference is required in some embodiments, in other embodiments, the ensemble obtained or trained in step 101 of FIG. 1 may be built by an ensemble building method that assigns different subspaces of the input space to different ensemble members. Such differences have no effect in the training or operation of the system illustrated in FIG. 4.

Each ensemble member 402A-C is a machine learning system that may or may not be a neural network. Each ensemble member has its individual objective 403A-C, respectively. In addition, the input vector to network 404 is the concatenation of the output vectors of machine learning systems 402A-C.

If the ensemble members 402A-C can also be trained by back propagation, e.g. if the ensemble members 402A-C are neural networks, then in a preferred embodiment the back propagation computation is carried backwards from the input to network 404 to the respective outputs of ensemble members 402A-C. In this embodiment, network 404 is referred to herein as a joint optimization network, not merely as a combining network. Any joint optimization network is also a combining network.

If the ensemble members 402A-C cannot be trained by back propagation, then network 404 is only referred to as a combining network. In this case, preferably network 404 is still trained to optimize objective 405, but without jointly optimizing ensemble members 402A-C. Further details on the training and operation of joint optimization networks are described in the aforementioned and incorporated Joint Optimization of Ensembles PCT Application.

FIG. 5 is a drawing of an example of a feed forward neural network. In this discussion, a neural network comprises a network of nodes organized into layers, a layer of input nodes, zero or more inner layers of nodes, and a layer of output nodes. There is an input node associated with each input variable and an output node associated with each output variable. An inner layer may also be called a hidden layer. A given node in the output layer or in an inner layer is connected to one or more nodes in lower layers by means of a directed arc from the node in the lower layer to the given higher layer node. A directed arc may be associated with a trainable parameter, called its weight, which represents the strength of the connection from the lower node to the given higher node. A trainable parameter is also called a “learned” parameter. Each node is also associated with an additional learned parameter called its “bias.” In some embodiments, there are additional elements not illustrated in FIG. 5. Other parameters that control the learning process are called “hyperparameters.” The neural network illustrated in FIG. 5 has an input layer, an output layer, and three hidden layers.

Based on the above description, it is clear that embodiments of the present invention can be used to improve many different types of machine learning systems, particularly neural networks. For example, embodiments of the present invention can improve recommender systems, speech recognition systems, and classification systems, including image and diagnostic classification systems, to name but a few examples.

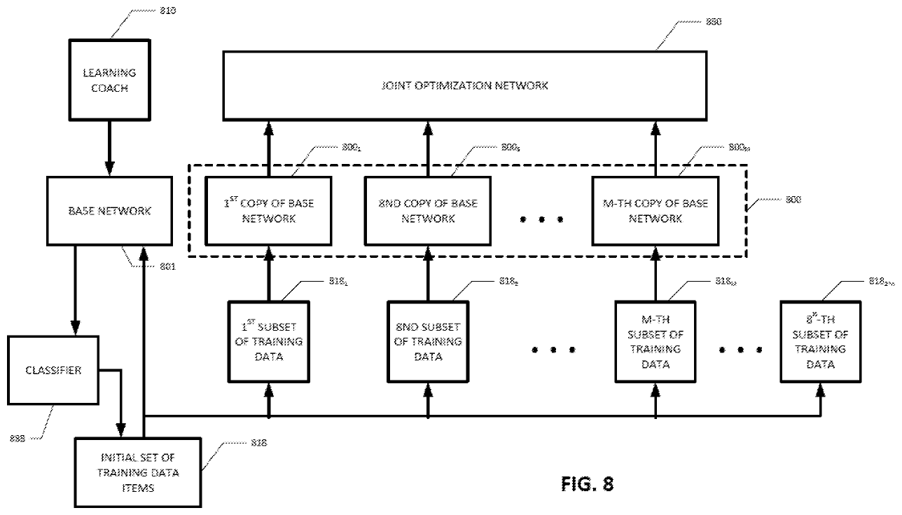

As described above, step 101 of FIG. 1 may employ a technique referred to as “blasting,” which is described below in more detail in connection with FIGS. 6 through 8. In Step 601 of FIG. 6, the computer system (see FIG. 3) obtains a neural network, called the “base” network 201 as shown in FIG. 8. The base network 801 may be pretrained, or it may be trained by stochastic gradient descent, as described above. The ensemble 800 may be built by making a number of copies of the base network (see step 604) and then training them to be different from each other and to optimize a joint objective. For example, M copies 800_{1-M} of the base network 801 may be made, where 2<M<2n, where n is quantity of network elements of the base network 801 that are selected as described further below.

In Step 605, the computer system does a feed forward computation to compute the node activations for each non-input layer node of the base network 801 for each training data item in an initial set of training data items 818. The computer system then does a back propagation computation to compute the partial derivative of the objective with respect to each non-input layer node activation and with respect to each of the learned parameters.

In Step 602, the computer system selects n network elements of the base network 801. Each selected element can be, for example, a node or directed arc in the network. The criteria for selecting the n network elements may be determined by the system developer or by the learning coach 810. The process illustrated in FIG. 6 works with any selection criterion and different selection criteria can used in various embodiments of the invention depending on the needs of the embodiments. Some embodiments select only nodes and no arcs; other embodiments select both; and still other embodiments select only arcs. As an illustrative example of a specialized selection criterion, only input nodes may be selected as the network elements at step 602 where an ensemble is to be built that is robust against adversarial attacks. Put another way, in various, embodiments, s nodes are selected and t directed arcs are selected, where s+t=n, and where 0<s<n and 0<t<n.

The selection of n network elements enables an ensemble creation process, herein called “blasting” to distinguish it from other ensemble building methods such as bagging and boosting. In blasting, up to 2n ensemble members 800_{1-M} (where 2<M<2n) are created at once and each is trained to change its learned parameters in a different direction, like the spread of the fragments when an explosive blast is used to break up a rock. The value of n may be set by the system developer or may be determined by the learning coach 810 based on prior experience. The process of FIG. 6 works for n=1, but it is recommended that n>1.

In one embodiment, in Step 606, the computer system partitions the training data 818 into 2n disjoint subsets 818_{1-2\hat{ }n}, so n should not be too large. Let D be the number of training data items, not counting data set aside for validation testing. In some embodiments, reasonable choices for the value of n are:

n=2, if D≤500;

n=2 or 3, if 500<D≤1000;

n=3, if 1000<D≤8000;

n≅log 2(D)−10, if D>8000.

In other embodiments, the 2n subsets may be allowed to overlap such that there are 2n subsets, but the subsets are not necessarily disjoint. In some embodiments, each of the 2n subsets is unique (i.e., do not overlap completely) although not disjoint. In some embodiments, not all 2n subsets are unique. However, in such an embodiment, M subsets may be selected, where M<2n, such that each of the M subsets is unique. In some embodiments, the M selected subsets are not necessarily unique.

The property that each ensemble member 800_{1-M} is trained on a disjoint subset 818_{1-2\hat{ }n} allows a data item that is used for training one ensemble member to be used for development testing or cross validation of another ensemble member. Furthermore, having a large number of ensemble members and the availability of cross-validation data enables the computer system to train the ensemble to avoid or correct for the overfitting that would otherwise result from using a small training set for an ensemble member. Although to a lesser degree, development testing and cross-validation are also facilitated in a modified version of this embodiment in which the training set of each ensemble member is not disjoint but in which each training data item is only used in training a small fraction of the ensemble members. That is, there could be an upper limit (F) on the number of subsets that each training data example can be placed into. For example, if F equals five, no training data examples could be put into more than five of the M subsets.

In some embodiments, it is desirable to generate a larger number of ensemble members each with a relatively small disjoint set of training data items. In such an embodiment, reasonable choices for the value of n are:

n=2, if D≤255;

n≅log 2(D)−6, if D>255.

In an illustrative embodiment, in step 603, the computer system begins a loop that goes from Step 603 through Step 607. Each loop creates a copy of the base network so the loop may be repeated M times to create the M copies of the base network 800_{1-M}. In some embodiments, the loop is executed 2n times to select all possible n-bit Boolean vectors. The number of different directions in which the learned parameters (e.g., directed arc weights and/or activation function biases) can be changed can correspond to the 2n different vectors in the n-bit Boolean vectors. In some embodiments, the Boolean vector is selected at random without replacement for some number of vectors m<2n.

The kth bit in the n-bit Boolean vector (where 1<k<n) indicates whether the sign of the derivative of the objective with respect to the kth network element selected in Step 602 should be positive or negative as part of the data selection process in Step 606.

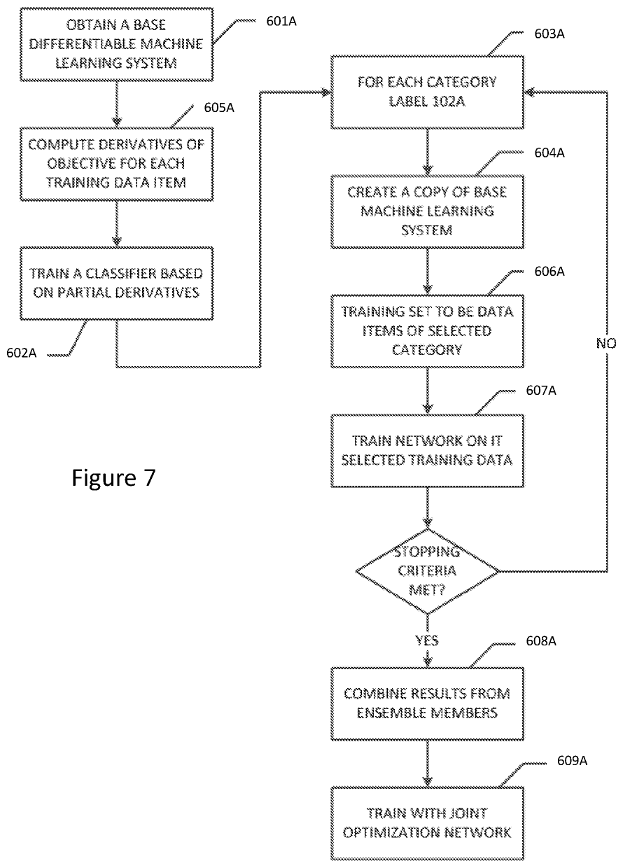

The purpose of step 603 is to partition the initial set of training data 818 into the subsets 818_{1-2\hat{ }n} such that training an ensemble member 800m on a specific subset will cause that ensemble member to be trained in a direction different from the direction of other ensemble members. For this purpose, step 603 is merely an illustrative example. Other embodiments may use other methods for creating this partition of the training data. Another illustrative example is discussed in association with FIG. 7.

The number of training data items assigned to each ensemble member will vary from one ensemble member to another. For some ensemble members, the number of assigned training data items may be very small or may even be zero. In some embodiments, any ensemble member with less than a specified number of assigned training data items may be dropped from the set of ensemble members. In general, there is no requirement that there be an ensemble member for each of the possible n-bit Boolean vectors.

In some embodiments a training data item may be assigned to more than one ensemble member 800_{1-M}. The data split in step 603 or in similar steps in other embodiments is used to indicate a preference that a training data item be assigned to an ensemble member associated with a bit vector agreeing with the bit vector for the data item. For example, for each training data item and for each ensemble member there can be an associated probability that the training data item be assigned to the training set for the ensemble member. Preferably, the probability of assignment is largest for the ensemble member specified in step 603. The assignments are not necessarily mutually exclusive, so the assignment probabilities for a training data item may sum to a number greater than 1.0. In these embodiments, the computer system keeps a record of the assignments for each training data item. This record is to be used for various purposes, such as in step 606.

In an illustrative embodiment, in Step 604, the computer system makes a copy 800m of the base network (the m-th copy, where m=1, . . . , M). This m-th copy of the base network 801 specifies the architecture of a new ensemble member and the computer system copies the learned parameters of the base network 801 to initialize the values of the learned parameters for a new ensemble member.

In one embodiment, in Step 606, the computer system, for each training data item in the initial set 818 for each k, checks the agreement between the kth bit in the n-bit Boolean vector selected in Step 603 and the sign of the partial derivative of the kth network element selected in Step 602. For example, the n-bit Boolean vector may comprise a sequence of n values, where each value in the sequence assumes one of two values, such as 0 and 1. Agreement can be considered to exist between the kth bit of the n-bit Boolean vector and the sign of the partial derivative of the kth network element if (1) the kth bit of the n-bit Boolean vector is 0 and the sign of the partial derivative of the kth network element is negative, or (2) the kth bit of the n-bit Boolean vector is 1 and the sign of the partial derivative of the kth network element is positive. If the kth network element is a node, the kth bit in the Boolean vector is compared with the sign of the partial derivative with respect to the activation value of the node. If the kth network element is an arc, the kth bit in the Boolean vector is compared with the sign of the partial derivative of the objective with respect to the weight parameter associated with the arc. If there is agreement for all n bits of the Boolean vector, then the training data item is selected for training the m-th copy of the base network created in Step 604. This process can be repeated for each training data item in the initial set 818 to generate the subset of training data for training the m-th copy. Moreover, as described above, the loop from steps 603 to 604 can be repeated M times, where 2<M<2n, to create the M copies of the base network 801, each being trained with a set of training data as described herein.

As mentioned above, in some embodiments, a training data item may be assigned to more than one ensemble member. In such an embodiment, in Step 606, for each training data item, the computer system checks the record created in step 603 to check whether the training data item is assigned to the ensemble member for the current pass through the loop from step 603 to step 607. In Step 607, the computer system trains the m-th network copy made in Step 604 on the training data selected in Step 606. Once trained, this m-th network copy becomes a member of the ensemble 800 being created.

After Step 607 is completed, the computer system returns to Step 603 until a stopping criterion is met. For example, the stopping criterion may be that all possible n-bit vectors have been selected in Step 603 or that a specified number of n-bit vectors has been selected. When the stopping criterion of Step 607 has been met, the computer system proceeds to step 608. In step 608, the computer system adds a mechanism for computing a single resulting output based on the output values of the ensemble members 800_{1-M}. There are several well-known methods for combining the results of ensemble members. For example, the combined result may be the arithmetic mean of the results of the individual ensemble members 800_{1-M}. As another example, the combined result may be the geometric mean of the results of the individual ensemble members. Another example, in the case of a classification problem, is that the classification of each ensemble member be treated as a vote for its best scoring output classification. In this example, the classification for the combined ensemble 800 is the category with the most votes even if it is not a majority.

In some embodiments the process of creating and training the ensemble 800 is complete after step 608. In some embodiments, the computer system proceeds to Step 609 for joint optimization of the ensemble. In Step 609, the computer system integrates all the ensemble members 800_{1-M} into a single network by adding a joint optimization network 880 and performs training with joint optimization. In joint optimization training, a neural network that replaces and generalizes the combining rule for the ensemble is created. This joint optimization network 800 is trained by stochastic gradient descent based on estimated gradients computed by back propagation of partial derivatives of the joint objective. The joint optimization network receives as input the concatenation of the output vectors of all the ensemble members 800_{1-M}. The back propagation of partial derivatives of the joint objective proceeds backwards from the input to the joint optimization network 880 to the output layer of each of the ensemble members 800_{1-M} and then backwards through each ensemble member network 200_{1-M}. A description of a joint optimization network and training with joint optimization is given in international patent application WO 2019/067542 A1, published Apr. 4, 2019, entitled “Joint Optimization of Ensembles in Deep Learning,” which is incorporated herein in its entirety.

FIG. 7 a flow chart of another illustrative embodiment. The process illustrated in FIG. 7 is similar to the process illustrated in FIG. 6, except step 602A uses a different method for partitioning the training data from the method used in step 602 of FIG. 6. Steps 603A, 606A, 607A, and 609A are modified in accordance with the change in step 602A. The other steps of the process, 601A, 605A, 604A, and 608A are essentially unchanged, except they may be generalized to apply to a machine learning system other than a neural network.

In step 601A, the computer system obtains a machine learning system (e.g., the base network 801) in which it is possible to compute the derivative of the objective with respect to the learned parameters; for example, the machine learning system obtained in step 601A may be a neural network as in step 601 of FIG. 6. In the case in which the obtained machine learning system is a neural network, step 601A is similar to step 601 in FIG. 6 and step 605A is similar to step 605 in FIG. 6. However, even when the machine learning system obtained in step 601A is a neural network, step 602A is different from step 602 in FIG. 6 in that Step 602A does not require the machine learning system obtained in step 601A to be a neural network nor does step 602A require the machine learning system obtained in step 601A to be trained by stochastic gradient descent based on back propagation.

In step 605A, the computer system computes the partial derivative of the objective of the machine learning system obtained in step 601A with respect to each learned parameter for each data item. In step 605A, the computer system also optionally computes the partial derivative of the objective of the machine learning system obtained in step 601A with respect to other elements of the machine learning system obtained in step 601A, such as with respect to the node activations in a neural network.

In step 602A, the computer system trains a machine learning classifier 888 to classify the training data items in the initial set into various classification categories (e.g., 2n different categories). The input variables to the classifier 888 are the values of the partial derivatives computed by the computer system for each training data item in step 605A. In step 602A, the computer system may train the classifier 888 using supervised, unsupervised, or semi-supervised learning in various embodiments.

In various embodiments, the classifier 888 in step 602A may be any form of classifier, for example it may be a decision tree, a neural network, or a clustering algorithm. In various embodiments, the classifier 888 in step 602A may be trained with supervised learning or with unsupervised learning, using any of many training algorithms that are well-known to those skilled in the art of training machine learning systems, with the training algorithms depending on the type of classifier.

In one illustrative embodiment, output targets for supervised learning are the n-bit Boolean vectors used in step 602 of FIG. 6. In this embodiment, the number n of network elements may be greater than the number n of network elements that would normally be used in step 602 in an implementation of FIG. 6. In this embodiment, there is be no limit on the number n of network elements.

In some embodiments, the training of the classifier 888 in step 602A may be based in part on a measure of distance between pairs of data items, such that, for example, data items that are close in distance according to the selected measure may be classified to a common classification category. In some embodiments, such as for unsupervised learning in general or for unsupervised or partially supervised clustering algorithms, a distance measure may be used that weights a change in the sign of a partial derivative more heavily than a change of the same magnitude that does not cause a change in the sign of the partial derivative. For example, let D1(j) represent the partial derivative on an objective with respect to element j of a machine learning system evaluated for a first training data item d1, and let D2(j) represent the partial derivative of the objective with respect to the same element j evaluated for a second training data item d2. An example formula for the distance between training data item d1 and training data item d2 may be defined by:

D(d1,d2)=Σⱼα*min(|D1(j)−D2(j)|,β)+(1−α)(sign(D1(j))−sign(D2(j))

where α is a hyperparameter that controls the relative weight given to the absolute difference compared to the weight given to the difference in the signs of the signs of the partial derivatives, and β is a hyperparameter that limits the maximum contribution to the distance measure from the absolute difference. Other distance measures may be used. Some embodiments give substantial relative weight to the signs of the derivatives, e.g. by using a limit like β in the example. Another example formula for the distance is defined by:

D(d1,d2)=Σⱼ|D1(j)−D2)j)|*|sign(D1(j)−sign(D2(j)|

In step 603A, the computer system begins a loop that cycles through each output category for the classifier of step 602A, or for each cluster if step 602A uses a clustering algorithm. In step 604A, the computer system creates a copy 800_{1-M} of the base machine learning system 801 obtained in step 601A. This copy of the base machine learning system 801 is a new ensemble member. In step 606A, the computer system sets the training set of the new ensemble member 800m created in step 604A to be the set of training data items classified by the classifier of step 602A to be in the category or cluster specified in step 603A. In step 607A, the computer system trains the ensemble member 800m created in step 604A by supervised learning based on the training data selected in step 606A.

When step 607A is completed for an ensemble member, the computer system goes back to step 603A until a stopping criterion is met. For example, a stopping criterion may be that all the classification categories that have been assigned more than a specified minimum number of data items have been processed through the loop from step 603A to 607A.

If a stopping criterion has been met, the computer system proceeds to step 608A. In step 608A the computer system adds a mechanism for computing a single resulting output based on the output values of the ensemble members 800_{1-M}. Step 608A is the same as step 608 in FIG. 6. In some embodiments the process of creating and training of the ensemble 800 is then complete. In some embodiments, the computer system proceeds to Step 609A.

In Step 609A, the computer system integrates all the ensemble members into a single network by adding the combining network 880. The combining network 880 is initialized to emulate the combing rule used in step 608A. The combining network 880 is then trained to optimize the shared objective. If the ensemble members can be trained by back propagation, e.g. if the ensemble members 800_{1-M} are neural networks, then the back propagation computed in training the combining network is back propagated to the output of each ensemble member so that the ensemble members are jointly optimized, as in step 609 of FIG. 6.

As previously mentioned, in FIG. 1A, computed or estimated partial derivatives with respect to the input can be used as data for a secondary objective. Techniques for performing exemplary embodiments of this technique are describe below in connection with FIGS. 11-13. FIG. 11 is a flow chart depicting a method of improving a first deep neural network (e.g., a deep feedforward neural network such as shown in FIG. 5) based on computations by a second deep neural network that uses a different objective than the first deep neural network and that uses as input one or more values computed in the back-propagation computation for the first deep neural network that are computed using the first deep neural network's objective. The first and second networks may be, for example, subnetworks 1150, 1160 of a main neural network 1100 according to various embodiments. FIG. 11 focuses on a node 1101 in a hidden layer of subnetwork 1150 of the main neural network 1100. Nodes 1102, 1103, and 1104 represent nodes in a lower layer of neural network 1100 that are connected to node 1101 with trainable connection weights. Preferably, neural network 1100 is trained by stochastic gradient descent based on minibatches or gradient descent based on the full batch of training data. Preferably, the computation used for estimating the partial derivatives in the gradient is a computation called back propagation, which is an implementation of the chain rule of calculus and is well-known to those skilled in the art of training neural networks. The gradient is a vector of partial derivatives of an objective function 1120 or 1130 with respect to each of the trained parameters. Typically, the trained parameters comprise connection weights, such as those connecting nodes 1102, 1103, and 1104 with node 1101, and a bias for each node, such as node 1101. The back propagation computation computes an estimate for the partial derivative of an objective function for each example of training data for each trainable parameter.

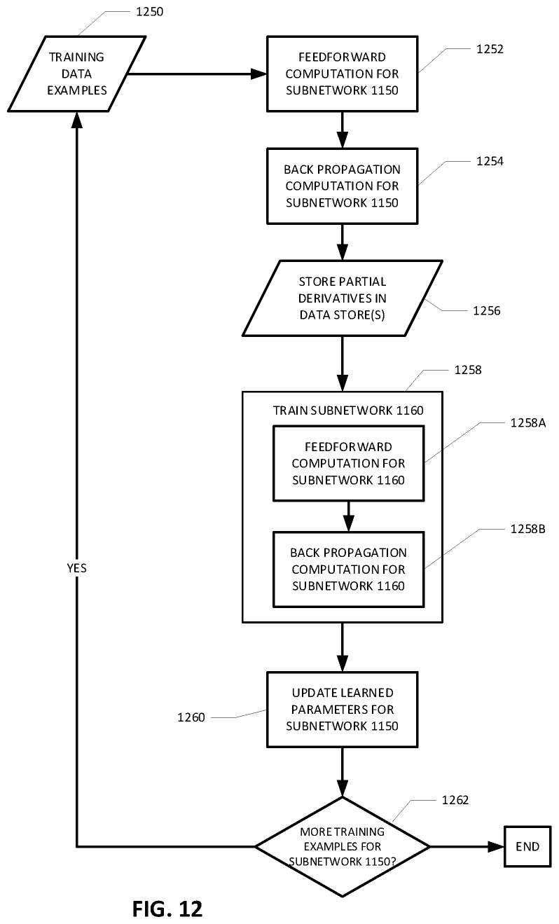

Each node in a neural network is associated with a function, called its activation function, which is a simplified model for the activation of a neuron in a biological nervous system. The activation function specifies the output or activation of the node for each possible input. Generally, the input to a given node is a weighted sum of the outputs or activation values of the nodes connected to the given node each multiplied by its associated connection weight. With reference to the flow chart of FIG. 12, preferably, for each training data example 1250, the computation has two phases, a feedforward computation and a back propagation computation. In the feedforward computation for the subnetwork 1150, shown at step 1252 in FIG. 12, for target node 1101, the weighted sum of values it receives from 1102, 1103, and 1104 respectively is computed, which sum is added to a bias term. Then, the output activation function for target node 1101 is computed, which node 1101 then feeds forward to nodes higher in the subnetwork 1150, represented by nodes 1105 and 1106. The feedforward computations can be performed for the other nodes in the subnetwork 1150, including nodes 1105 and 1106.

The second phase is the backpropagation computation, shown at step 1254 of FIG. 12, which begins with an objective function 1120. For example, in supervised training of a classification task, each training data example has a designated target classification. The objective function may be a loss function, which is a measure of the cost or loss associated with any deviation of the output of the network from the designated target classification. For example, the objective may be the cross-entropy between the output of the network and the vector that is zero in every position except the designated target for which the value is one. In the back propagation computation, the estimated partial derivatives of the objective with respect to the elements of the network begins with the derivatives of the objective with respect to the output values of the network, that is, the activation values of the output layer of the network. The estimated partial derivatives are propagated backwards through the network according to the chain rule of calculus, until the estimated partial derivatives are propagated back from nodes 1105 and 106 through their connections to target node 1101. In addition to the partial derivative of the objective defined by the cross entropy or other loss function determined at the output of the network, there may be additional terms in the objective applied at other points in the network through a process called regularization, which is a process well known to those skilled in the art of statistical estimation with regularization.

Still as part of the back propagation process, the estimated partial derivative of the objective 1120 with respect to the output activation of node 1101 is computed. Next, the estimated partial derivative of the objective with respect to the value that was input to node 1101 during the feed forward computation is computed. The back propagation computation continues by computing the estimated partial derivatives of the objective with respect to the bias to node 1101 and to the weights associated with the connections from nodes 1102, 1103, and 1104, respectively. If the bias for node 1101 is an additive term to the weighted sum of its other inputs, then the partial derivative of the objective with respect to the input to node 1101 is the same as the partial derivative of the objective with respect to the bias for node 1101.

Some neural network models have specialized structures that differ in the details, but generally they all share the property that the back propagation computation computes an estimate of the partial derivative of an objective with respect to each node, such as node 1101, as part of the process of computing estimated partial derivatives of an objective with respect to the trainable parameters.

The illustrative embodiment illustrated in FIG. 11 does not depend on the details of the back propagation computation. In fact, it does not require that back propagation be the form of computation of the estimates of the partial derivatives. This illustrative embodiment merely requires that, by some method, an estimate of the partial derivative of an objective with respect to either the output activation of node 1101 and/or the input to node 1101 has been obtained. Optionally, estimated partial derivatives of an objective with respect to the connection weights associated with the connections to node 1101 from nodes 1102, 1103, and 1104, respectively, have also been obtained. For example, all of these partial derivatives are estimated for each node and each connection weight by the well-known back propagation computation.

After the partial derivatives have been estimated, the estimated partial derivative with respect to the output of and/or the input to node 1101 is saved in data store 1111 at step 1256, and the estimated partial derivatives with respect to the weights associated with the connections from nodes 1102, 1103, and 1104 are saved in data stores 1112, 1113, and 1114, respectively. The values stored in data stores 1111, 1112, 1113, and 1114 are then provided as input to a second subnetwork 1160 for training the second subnetwork 1160, at step 1258. The data stores 1111-1114 may be implemented with, for example, primary and/or secondary computer memory (computer memory that is directly (primary) or not directly (secondary) accessible by the processor(s) cores) of the system, as described further below.

In the embodiment illustrated by FIG. 11, the training for subnetwork 1160 is different from the two-phase training computation for subnetwork 1150 (which comprises a feed-forward activation computation (step 1252) followed by a back propagation computation (step 1254)). With reference to FIG. 11, to train the subnetwork 1160 at step 1258, the subnetwork 1160 receives input from the data store 1111 and, optionally, from data stores 1112, 1113, and 1114. The data from these data stores is not available until the back propagation computation for subnetwork 1150 at step 1254 has proceeded backwards at least to target node 1101 (including its incoming weights). In a preferred embodiment, the subnetworks 1150 and 1160 are disjoint with no connections from subnetwork 1160 to subnetwork 1150. In this embodiment, the feed forward computation for subnetwork 1160 at step 1258A is delayed until after the back propagation for subnetwork 1150 at step 1254 has been completed. Connections from subnetwork 1150 to subnetwork 1160 are allowed, since the activations for all of subnetwork 1150 are computed at step 1254 before the feed forward computation for subnetwork 1160 at step 1258A.

In other embodiments, an iterative process is used in which there is an alternation between a feedforward computation on all of network 1100 followed by a back propagation computation on all of network 1100, with the alternation repeating until a convergence criterion is met (e.g. the applicable error function is not reaching a threshold minimum). Generally, an embodiment with disjoint subnetworks 1150 and 1160 is preferred.

The back propagation computation for subnetwork 1160 at step 1258B begins with a second objective 1130 and optionally also includes the main objective 1120. The back propagation computation for subnetwork 1160 then proceeds according to the well-known back propagation algorithm, applied to subnetwork 1160. However, if there are connections from nodes in subnetwork 1150 that are connected to nodes in subnetwork 1160, in some embodiments, the new estimated partial derivatives back propagated from subnetwork 1160 to subnetwork 1150 are computed and added to the partial derivatives estimated in the back propagation computation of subnetwork 1150 and are used in updating the learned parameters for the subnetwork 1150 at step 1260. However, new partial derivatives combining the objectives of subnetworks 1150 and 1160 need not, and preferable are not, stored in data stores such as 1111, 1112, 1113, and 1114. Thus, the back propagation from subnetwork 1160 does not change the values input to subnetwork 1160.

Steps 1252-1260 can be repeated for a number of training examples for the subnetwork 1150, as indicated by the feedback loop from the decision block 1262 to the training data examples 1250. Trained in such a manner, the subnetwork 1160 has information that is not available to a conventional feed forward or recursive neural network. Using this information, subnetwork 1160 can compute classifications and regression functions that cannot be computed by any conventional feed forward network, no matter how complex. As an illustrative example, subnetwork 1160 has input comprising the output activation value of the target node 1101 as well as the partial derivative of the main objective 1120 both with respect to the output activation of node 1101 and with respect to the input to node 1101. If the partial derivative of objective 1120 has a large magnitude with respect to the output activation value of node 1101, it means that changes in the activation of node 1101 would have a large effect on the classification by network 1100 and on the value of objective 1120. This computation can be performed separately on each training data example, as shown in FIG. 12. In various embodiments, the results of these computations may be accumulated over each minibatch used for training the subnetwork 1150 and may even be accumulated over larger sets, herein called macrobatches, or the full batch comprising all the training data for training the subnetwork 1150.

For each data example and for any of the batches, the subnetwork 1160 also has the value of the estimated partial derivative of the main objective 1120 with respect to the input to node 1101. Even on a data example for which the magnitude of the partial derivative of the main objective 1120 with respect to the output activation of node 1101 is very large, the magnitude of the estimated partial derivative of the main objective 1120 with respect to the input to node 1101 may be very small. This situation may occur whenever the input to node 1101 is at a point in the activation function with a derivative that is close to zero. The magnitude of the derivative of the main objective 1120 with respect to the output of node 1101 only depends on the partial derivatives of nodes higher in the network than node 1101, such as nodes 1105 and 1106, and on the weights by which node 1101 is connected to them. This magnitude does not depend on either the activation value of node 101 or on the value of the derivative of the activation function of node 1101 at that activation value.

It is quite likely that the low magnitude partial derivative of the objective 1120 with respect to the input to node 1101 on this one data example will be swamped by larger magnitude partial derivatives for other data items, so node 1101 might not be trained in the direction desirable for this data example.

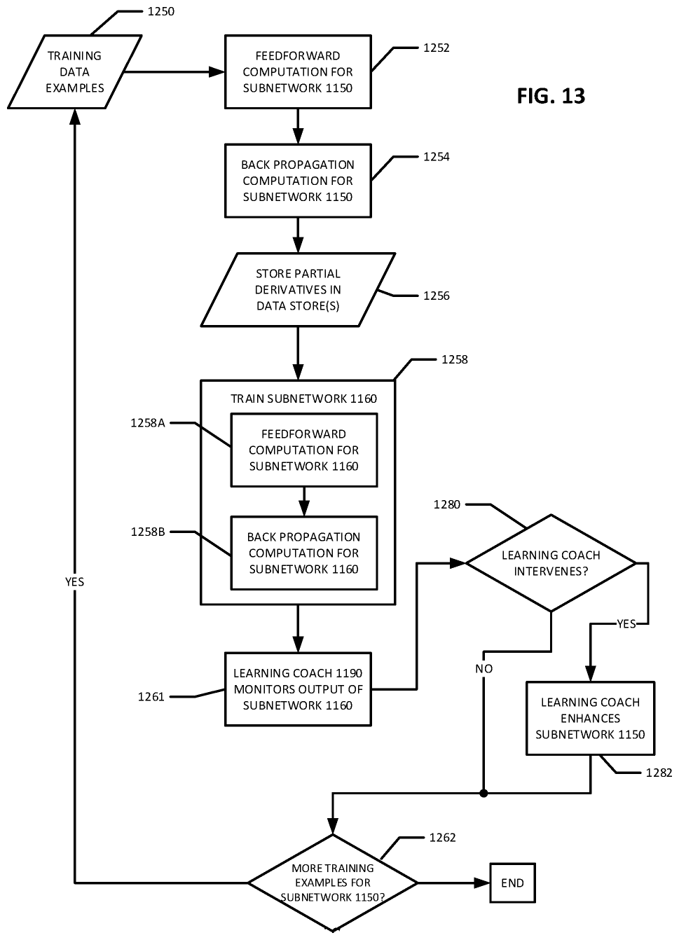

Subnetwork 1610 has the necessary information to detect this problem in the learning process for the subnetwork 1150 and to activate an output node that sends a signal of the problem and that even identifies node 1101 in the subnetwork 1150 as the affected node. This signal can trigger corrective action for the subnetwork 1150. For example, in an illustrative embodiment, shown in FIG. 13, a learning coach 1190, at step 1261, monitors the output of subnetwork 1160 and may choose, at step 1280, to intervene in the learning process for the subnetwork 1150, for example by, at step 1282, setting a customized value of a hyperparameter for the subnetwork 1150, such as learning rate or temperature, customized for node 1101, as well as giving extra weight to a training example. Learning coach 1190 may intervene in the learning process in other ways, such as changing the architecture of the network (e.g., adding a node to a selected layer and/or adding a new layer) or doing data selective training. In some embodiments, other means of fixing or reducing the problem may be used.

In other embodiments, the processes shown in FIGS. 12 and 13 can be combined; they are not necessarily mutually exclusive. For example, if there are connections from nodes in the subnetwork 1150 that are connected to nodes in subnetwork 1160, the new estimated partial derivatives back propagated from subnetwork 1160 to subnetwork 1150 may be computed and added to the partial derivatives estimated in the back propagation computation of subnetwork 1150 to update the learned parameters for the subnetwork 1150 at step 1260 of FIG. 12. In addition, the learning coach 1190 can monitor the outputs of the subnetwork 1160 to determine whether, and how, to intervene to enhance the subnetwork 1160, as shown in steps 1280-1282 of FIG. 13.

In various embodiments, there could be additional subnetworks 1160, each for a separate target node in the subnetwork 1150, with such other subnetworks 1160 being trained and computing improvements for the subnetwork 1150 in the same was as described herein. Also, in the description above, the subnetwork 1160 received as inputs the partial derivatives about a single node 1101 in the subnetwork 1150. In other embodiments, the subnetwork 1160 may also receive as inputs partial derivatives for other (or all of) the nodes in the subnetwork 1150, such as nodes 1102-1106, for example.

Also as previously mentioned, in the process of in FIG. 1A, the computer system can create or enhance the diversity of ensemble members by having a secondary objective with a vector of target values for the estimated input sensitivities for each ensemble member. A technique for training for such a secondary objective in addition to the primary classification or regression objective is now described in connection with FIGS. 9 and 10. At Step 901 of FIG. 9, the computer system selects a set of nodes of the deep neural network and a secondary objective function to be optimized. The secondary objective preferably is a function of the partial derivatives of a specified primary objective with respect to the values of the learned parameters and other attributes of the deep neural network. The primary objective may be associated with a classification task, with a prediction or regression task, or with some other pattern analysis or generation task (e.g., data generation or synthesis). The selected node subset may comprise, for example: (i) a node or nodes on a single inner layer of the neural network; (ii) a node or nodes on the input layer; or (iii) nodes on two or more different layers of the neural network (e.g., two or more inner layer or one or more inner layers plus the input layer). Also, in an illustrative embodiment, the secondary objective function (as opposed to the primary objective function) to be optimized is a function of the values of the partial derivatives of the primary objective with respect to the activation value of each of the selected nodes. As an example, the primary objective may be the error cost function or loss function in a classification task. In this illustrative example, the selected set of nodes may be the set of nodes in the input layer, with the neural network being a feed forward neural network. On an item of training data, the activations of the nodes in the network are computed by a feed forward computation (step 903 in FIG. 9) and the partial derivatives of the primary objective (e.g., the error cost function) are computed by a back propagation computation (step 104 of FIG. 1). These feed forward and back propagation computations are well-known to those skilled in the art of training deep neural networks.

The back propagation computation may be extended backwards an additional step that is not used in normal training of a neural network. This extra step of back propagation, at step 906 of FIG. 9, computes the partial derivatives of the primary objective with respect to the input values, which are also the activation values for the nodes in the input layer. One implementation of this extra step of back propagation is to give each input node a dummy bias, e.g., setting the value of the bias to zero. Generally, without changing any code, an existing back propagation procedure can compute the partial derivative of the primary objective with respect to the bias parameter associated with each input node, which is the same as the partial derivative of the primary objective with respect to the activation value of the associated input node. The value of the dummy bias, however, is not updated, but is left as zero. Any other equivalent computation may be used instead to compute the partial derivative of the primary objective with respect to the activation value of each input node.

In this illustrative embodiment, the selected nodes are the input layer nodes and the secondary objective is a norm of the vector of partial derivatives of the primary objective in which there is one element of the vector for each input layer node in the network. The norm may be, for example, the L2 norm. The mathematical definition of the L2 norm is the square root of the sum of the squares of the values of the elements of the vector. In this case, the L2 norm is the square root of the sum of the squares of the values of the partial derivatives of the primary objective with respect to the activation values of the input nodes. For numerical convenience, in some embodiments and in this discussion, the L2 norm is represented instead by ½ times the sum of the squares of the partial derivatives of the primary objective with respect to the activation values of the input nodes, that is without taking the square root. As another example, the secondary objective may be the L1 norm of the vector of partial derivatives of the primary objective with respect to the inputs. The L1 norm of a vector is the sum of the absolute values of the elements of the vector.

This illustrative example of a secondary objective may be used to make the neural network more robust against deviations in the input values from their normal values. Decreasing either of these norms of the derivatives of the primary objective will decrease the sensitivity of the classification or regression computed by the neural network to changes in the input values, whether those changes are caused by random perturbations or by deliberate adversarial action.

As another example, some set of nodes other than input layer nodes may be selected at step 901, such as a node(s) on one or more inner layers. For example, a set of inner layer nodes may be selected because they represent features of particular interest, such phonemes in speech: eyes, mouth, and nose in an image of a face; or proper nouns in a text document. As another example, a set of inner layer nodes may be selected because it has been empirically discovered that their levels of activation influence the success and robustness of the task of the network; for example, such a selection criterion might be applied in the loop back from step 908 to step 901 in FIG. 9.

In any of these examples of a selected set of nodes with nodes from inner layers, a vector norm over the vector of partial derivatives of the primary objective with respect to the activation values of the selected nodes may be applied as described above for a selected set of input nodes.

In some embodiments, when a node from an inner layer is selected, the partial derivative of the primary objective to be associated with selected node is the partial derivative of the primary objective with respect to the output activation of the node. In other embodiments, the partial derivative to be used in the norm may be the partial derivative of the primary objective with respect to the input to the activation function. Some embodiments may use a mixture of the two choices. The extra choice that exists for a set of inner layer nodes does not exist for an input node as previously discussed, since for an input node the output of the node is the same as the input.

The selection of a secondary objective and of a set of nodes to participate in that secondary objective may be specified by a system developer or may be controlled by a separate machine learning system called a learning coach. A learning coach is a separate machine learning system that learns to control and guide the learning of a primary learning system. For example, the learning coach itself uses machine learning to help a “student” machine learning system, e.g., the neural network trained according to the method of FIG. 1. For example, by monitoring the student machine learning system, the learning coach can learn (through machine learning techniques) “hyperparameters” for the student machine learning system that control the machine learning process for the student learning system. For example, in the case where the student machine learning system uses a deep neural network (DNN), the learned hyperparameters can include the minibatch size M, the learning rate η, the regularization parameter λ, and/or the momentum parameter μ. Also, one set of learned hyperparameters could be used to determine all of the weights of the student machine learning system's network, or customized learned hypermeters can be used for different weights in the network. For example, each weight (or other trainable parameter) of the student learning system could have its own set of customized learned hyperparameters that are learned by the learning system coach. Also, the learning coach may select the secondary objective and/or the set of nodes to participate in the secondary objective training described in connection with FIG. 9.

In some embodiments, a secondary objective of a different type than a norm of the component partial derivatives may be specified at step 901. For example, a learning coach may specify a target value for each partial derivative for a selected set of nodes and the secondary objective may be an error cost function based on the deviation of the actual value of each partial derivative from its target value. This type of objective is often used for the primary objective and is well-known to those skilled in the art of training neural networks.

At Step 902 of FIG. 9, which is optional, the computer system modifies the activation functions of one or more nodes. In a preferred embodiment, the modification in an activation function is designed to make certain aspects of the partial derivatives that are to be measured by a secondary objective more prominent. For example, for a secondary objective that seeks to minimize a norm of the vector of partial derivatives of the primary objective on a set of nodes, the modification to an activation function may smooth out an activation function such that a large sudden change in the activation function as a function of its input may be spread out over a broader region of input values so that the effect of the large change in the activation function will be observable for a wider range of input values to the activation function. This change in the activation function may help make the potential influence of the large change in the activation function observable in the norm computed in the secondary objective function for a greater variety of data items.

As an illustrative example, let the activation function for a node be the sigmoid function, defined by sigmoid(x)=1/(1+exp(−x)). The sigmoid function may be modified by adding a hyperparameter T, called temperature and the parametric sigmoid function may be defined by sigmoid(x; T)=1/(1+exp(−x/T)). The normal sigmoid function is equivalent to a parametric sigmoid function with the value of the hyperparameter T=1. The activation function may be changed to a smoother activation function by changing the hyperparameter T to a value greater than 1.

As another illustrative example, any activation function may be smoothed by convolving it with a non-negative function that is symmetric around zero, such as g(x)=exp(−x²/T).

The value of the hyperparameter T may be set by the system developer, may vary based on a fixed schedule, or may be controlled by a learning coach. The amount of smoothing may depend on the phase of the learning process, as determined by step 908.

In addition, at step 902 the computer system may modify each activation function so that its derivative is bounded away from zero. For example, at step 902 the computer system may add a linear term to each activation function so that A(x)=f(x) becomes A(x)=f(x)+s*x, where s>0. The need for this modification will be apparent in the upcoming discussion of step 906.

For each item of training data, at step 903 the computer system computes the activation value of each node in the network with a feed forward computation that is well-known to those skilled in the art of training deep neural networks. In one preferred embodiment, this feed forward computation is done using the original, unmodified activation functions. In some embodiments, this feed forward computation is done using the modified activation function, for consistency with step 906.

For each item of training data, at step 904 the computer system computes the partial derivative of the primary objective with respect to each node in the network and each learned parameter, using the back propagation computation, which is well-known to those skilled in the art of training deep neural networks. In some embodiments, at step 904 the computer system adds an extra step to the back propagation computation, computing the derivatives of the primary objective with respect to the value of each input data variable, that is, with respect to the activation value of each node in the input layer. This extra step is necessary so that the partial derivatives with respect to one or more input layer nodes can be included in a secondary objective. In a preferred embodiment, there are two back propagation computations in step 904: a first computation using the original unsmoothed activation functions, which is used for computing the updates to the learned parameters; and a second computation using the smoothed activation functions. In this embodiment, the second back propagation computation uses the smoothed activation functions and the partial derivatives that it computes are used in step 906. In another embodiment, only the partial derivatives of the smoothed form of the activation function are computed and used both for the updates of the learned parameters and to supply partial derivatives of the secondary objective for step 906. In any of these embodiments, step 906 uses the smoothed activation functions for computing the forward propagation of the derivatives of the secondary objective. In an embodiment in which step 902 is skipped, the unmodified activation functions are used for both the updates of the learned parameters and to supply partial derivatives of the secondary objective in step 906.

At Step 905, the computer system sets limits on the values computed by step 906. At Step 906, the computer system computes partial derivatives of the secondary objective, which is itself a function of partial derivatives of the primary objective. Because the partial derivatives of the primary objective are computed by back propagation, that is, by going backwards through the network, partial derivatives of the secondary objective must be computed in the opposite direction, that is, going forwards through the network. Like back propagation, the computation done by step 906 is based on the chain rule of calculus and is shown in more detail in FIG. 10. FIG. 10 shows the start of the computation of the partial derivative of the secondary objective, at NODE m or NODE n. FIG. 10 then shows the detail of the forward propagation of the partial derivatives of the secondary objective through a typical node, NODE j. The function δ(k) represents the value of the derivative of the primary objective with respect to the output activation value of node k, as computed at step 104. Functions with two deltas, denoted δδ( ), are used to represent various partial derivatives of the secondary objective. For example, δδ_{INPUT}(j) represents the partial derivative of the secondary objective with respect to the input to NODE j and δδ_{OUTPUT}(j) represents the partial derivative of the secondary objective with respect to the output activation value of NODE j. Finally, δδ(i,j) represents the partial derivative of the secondary objective with respect to the connection weight from NODE i to NODE j.

Step 906 begins the process of computing the partial derivatives of the secondary objective with each node in the set of nodes selected in step 901. The formula for starting the computation depends on the type of objective function used for the secondary objective. If the objective is to minimize ½ the sum of the squares of the derivatives of the primary objective over a set of nodes containing NODE m (the simplified L2 norm), then δδ_{OUTPUT}(m)=δ(m). If the objective is to minimize the sum of the absolute values of the derivatives of the primary objective over a set of nodes containing NODE n, then δδ_{OUTPUT}(n)=sign(δ(n)). The function sign(x) is defined by sign(x)=−1 for x<0 and sign(x)=1 for x≥0. These two examples are shown in the bottom part of FIG. 10.

The rest of FIG. 10 shows the forward propagation of the derivatives of the secondary objective from nodes for which it has already been computed, such as NODE i, through NODE j and then on to nodes in higher layers. NODE i may be an initial node, such as NODE m or NODE n, or there may be intermediate layers between the initial nodes and NODE i. In any case, FIG. 10 shows the computation at a stage at which δδ_{OUTPUT}(i) has already been computed, and the value of δδ_{OUTPUT}(k) has also been computed for all lower layer nodes k that are connected to NODE j.

As shown in FIG. 10, at step 906 the computer system then computes the partial derivative of the secondary objective with respect to the connection weight from NODE i to NODE j by δδ(i,j)=δδ_{OUTPUT}(i)δ(j). This estimate of the partial derivative of the secondary objective with respect to the connection weight for the connection from NODE i to NODE j will be accumulated over a batch of data and then will be used as a term in computing the update to this weight parameter. Note that the batch size for computing estimates of the partial derivatives of the secondary objective may be different from the mini-batch size used for accumulating estimates of the partial derivatives for the primary objective. For example, it may be an integer multiple of the mini-batch size for updating the learned parameters based on the primary objective, as explained in association with step 907. When the learned parameters are being updated in part based on the secondary objective, there is an additional term in the update value. The additional term is the estimated negative gradient of the secondary objective multiplied by its learning rate.

As shown in FIG. 10, at step 906 the computer system then computes the partial derivative of the secondary objective with respect to the input to NODE j by δδ_{INPUT}(j)=Σᵢw_{i,j}δδ_{OUTPUT}(i). Note that the notation Act′(x;j) in FIG. 10 represents the derivative of the modified activation function for NODE j, evaluated at the point x that was the input value to NODE j computed during the feed forward computation in step 903. That is, in some embodiments, it is a somewhat ad hoc mix of a computation using values computed with the unmodified activation functions within a computation that uses the modified activation functions.

As shown in FIG. 10, at step 906 the computer system computes the partial derivative of the secondary objective with respect to the output of NODE j by

$${δδ}_{OUTPUT} ( j ) = {δδ}_{INPUT} ( j ) ( \frac{1}{{Act}^{′} ( x ; j )} ) .$$

Notice that the computation of δδ_{OUTPUT}(j) requires a division by the derivative of the activation function of NODE j. For the unmodified activation function, this computation might require a division by zero, which is why at step 902 the computer system can modify each activation function to be bounded away from zero.

However, bounding the derivative of each activation function away from zero may not be sufficient because the estimated partial derivatives of the secondary objective might still grow very large in magnitude. For example, although the value s in the linear term added in step 902 is greater than zero, it should not be so large that it makes a substantial change in the activation function. Thus, s may be small and 1/s may be large.

Preferably at step 105 the computer system imposes additional constraints to prevent the values computed in the forward computation at step 906 from growing too large in magnitude. For example, step 905 may impose a limit on the number of layers that a derivative of the secondary function may be propagated forward. In order to estimate updates for all the learned parameters, the back propagation of derivatives of the primary objective must be computed backwards through all the inner layers of the neural network. However, there is no such requirement on the forward propagation of derivatives of the secondary objective at step 906.

The system developer may set a fixed limit in step 905 on the number of layers to forward propagate any derivative of the secondary objective, or may set a stopping criterion on the forward computation. In some embodiments, a learning coach may dynamically adjust hyperparameters controlling a stopping criterion for the forward propagation of the derivatives of the secondary objective.

Instead, or in addition, some embodiments at step 905 may impose a limit on the maximum magnitude that may be assigned to a derivative of the secondary objective. This limit may be a fixed numerical value that is the same for all nodes in the network, or it may be individualized to each node. In some embodiments, this limit may be computed dynamically. For example, each derivative of the secondary objective may be limited to have a magnitude no greater than r times the corresponding derivative of the primary objective function, where preferably, 0<r<1. The value of r may be fixed; it may be changed by a predetermined schedule; or it may be a hyperparameter dynamically controlled by a learning coach. Having a value of r<1 helps prevent the term from the secondary objective from overwhelming the term from the primary objective in the parameter update computation in step 907.

Any of the limits discussed in the preceding paragraphs may be imposed as maximum allowed values. That is, any value greater than the limit is changed to the limit value. Alternately, a limit may be used to determine a scale factor. Then each derivative in a given layer is divided by the scale factor, so that the ratios of respective derivative values in the same layer is maintained.

Returning in FIG. 9, at Step 907, the computer system updates the trained parameters for the neural network, such as the connection weights and biases. Step 907 may also use other hyperparameters that help control the contribution to the updates from the secondary objective compared to contributions from the primary objective. For example, step 907 may use a lower learning rate for the term from the secondary function than for the term from the primary function.

At Steps 903 to 907 of FIG. 9, the computer system may train the neural network by an iterative process called stochastic gradient descent, which is well-known to those skilled in the art of training deep neural networks. In stochastic gradient descent, the training data items are grouped into batches called minibatches. For each data item, an estimate is made for the gradient of the objective based on the back propagation computation in step 904. The loop back from step 906 to step 903 is taken until this gradient update estimated from individual data items can be accumulated for all the data items in a minibatch.

Ignoring for the moment the contribution to the update from the secondary objective, this estimate of the gradient of the primary objective is multiplied by a number called the learning rate. Then all of the learned parameters are updated by changing them in the opposite or negative of the direction of the estimated gradient. The size of the step in the update is the product of the magnitude of the estimated gradient times the learning rate.

To incorporate the secondary objective, the updating of the trained parameters at step 907 may have additional hyperparameters and/or modify the process of stochastic gradient descent in several ways. In some embodiments, step 907 has a different learning rate for the secondary objective than for the primary objective. In addition, in an illustrative embodiment, at step 907 the computer system uses a larger minibatch for the secondary objective than for the primary objective. Preferably the minibatch size for the secondary objective is an integer multiple, say k, of the minibatch size for the primary objective. In this illustrative embodiment, step 907 only includes a term from the secondary objective once for every k minibatch updates associated with gradient of the primary objective. Thus, the influence of the secondary objective on the updates to the parameter is reduced by three successive multiplicative factors: (1) the factor r imposed in step 905; (2) the ratio of the learning rate for the secondary objective to the learning rate for the primary objective; and (3) the reciprocal of k, the number of primary objective minibatches per secondary minibatch.

In some embodiments, there may be an additional hyperparameter that controls the weight of the secondary objective relative to the primary objective based on other criteria. For example, this hyperparameter may be controlled as a form of regularization to lessen over fitting of the training data.

The hyperparameters determining these factors may be controlled by a learning coach and may vary from one phase of the learning process to another, as determined in step 908. At Step 908, the computer system checks for a change in the phase of the learning process. For example, in an illustrative embodiment, the hyperparameters may be controlled differently in three phases: (1) an early phase of learning, (2) a main learning phase, and (3) a final learning phase.

In an early phase of the learning process, smoothed activation functions may be used for both updating the learned parameters and for computing the derivatives of the secondary objective. In this early learning phase, the use of the smoothed activation functions for updating the learned parameters may help accelerate the learning process by preventing the activation function of a node from being in a portion of its range in which the magnitude of the partial derivative is small, such as for extreme positive and negative inputs for a sigmoid or for negative inputs for a rectified linear unit.

In this illustrative example, in the main learning phase the hyperparameters may be set to default values or may be adjusted according to a predetermined schedule. In a final learning phase, the learned parameters may be updated based on a primary objective computed with unmodified activation functions while the secondary objective is based on the smoothed activation functions. In another illustrative embodiment, the process illustrated in FIG. 1 is only applied in an extra phase of learning that is added after the regular learning process has reached some stopping criterion.

The changes in the hyperparameters may be controlled by a learning coach. A learning coach may determine the learning phase based on measurements of the activations and partial derivatives computed in feed forward and back propagation computations for a data item and also on comparisons across data items or across minibatches. A learning coach also may customize the values of the hyperparameters on a node-by-node basis.

In some embodiments, some of the hyperparameters used in step 902 are controlled for other purposes. For example, in some embodiments the regular activation function of some nodes may be a parametric sigmoid or some other parametric activation function with a hyperparameter like the temperature T in a parametric sigmoid function. Examples of the use of such a parametric activation function are discussed in published international application WO 2018/231708 A2, published Dec. 20, 2018 and entitled “ROBUST ANTI-ADVERSARIAL MACHINE LEARNING,” which is incorporated herein by reference in its entirety.

If there is no change in the phase of the learning process, step 908 returns control to step 903 unless a stopping criterion is met. A stopping criterion may be to detect convergence of the training process or a sustained interval of no improvement on a validation set. If there is a change in the phase of the learning process, control is returned to step 901.

In one general aspect, therefore, the present invention is directed to computer-implemented systems and methods for building and using an operational ensemble of machine learning systems that is robust against adversarial attacks. The method may comprise the step of training, with a computer system that comprises one or more processor units, a base ensemble having a plurality of machine-learning ensemble members such that the ensemble members have diversity with regard to sensitivity to changes in input variables, where the base ensemble comprises N>1 different subsets of the plurality of machine-learning ensemble members, and where each of the N subsets comprises one or more ensemble members of the plurality of machine-learning ensemble members. The method may also comprise the step of including, by the computer system, P of the N subsets of the ensemble members in the operational ensemble, where 2<P<N, based on whether the subsets pass a performance measure test and a diversity measure test, wherein the diversity measure test is based on a diversity measure for the subsets relative to each of the other subsets of the ensemble members. The method may also comprise the step of performing an operational machine-learning task with the operational ensemble on a data item, which may comprise the steps of (i) selecting (e.g., randomly or non-randomly), by the computer system, one of the P subsets of the ensemble members in the operational ensemble; and (ii) processing, by the computer system, the data item with the selected subset of the ensemble members to generate a final result for the machine-learning task for the data item. A computer system according to embodiments of the present invention may comprise one or more processor units that are programmed to perform the steps described above.

In various implementations, the one or more processor units of the computer system are programmed to include the P subsets in the operational ensemble by: (i) computing a performance measure of a first (n=1) subset of the ensemble members; and (ii) for n=2 to J, where P<J<N, iteratively: (a) computing a performance measure for the n-th subset of the ensemble members; (b) computing the diversity measure for the n-th subset of the ensemble members relative to each of the n=1, . . . , (n−1) subsets of the ensemble members; and (c) determining whether to include the n-th subset of the ensemble members in the operational ensemble based on the performance and diversity measures for the n-th subset of the ensemble members, such that following the n=J iteration, the operational ensemble comprises the P subsets of the ensemble members. Also, upon a condition that the selected subset comprises multiple ensemble members, the computer system may process the data item by: processing the data item with each of the multiple ensemble members of the selected subset; and combining a result from each of the multiple ensemble members to generate the final result.

In various implementations, the one or more processor units of the computer system are further programmed to, prior to training the base ensemble, build the base ensemble from a base machine-learning network. This may be done, for example, by: (i) selecting r selected network elements of a base-machine learning network, where r>1; (ii) making M copies of a base machine-learning network, where 2<M<2r; (iii) training each of the M copies of the base machine-learning network such that each of the M copies of the base machine-learning network is trained to change its learned parameters in a different direction than any of the other M copies; and (iv) combining the M copies of the base machine-learning network into the base ensemble. For example, the base machine-learning network may comprise a base neural network that comprises a plurality of nodes and plurality of directed arcs, where each directed arc is between two nodes of the base neural network. In that case, the t selected network elements may comprise u nodes of the base neural network and v directed arcs of the base neural network, where u and v are integers greater than or equal to zero, and where u+v=t.

In various implementations, the one or more processor units are programmed to train the base ensemble such that the ensemble members have diversity with regard to sensitivity to changes in input variables by training each of the N subsets of the ensemble members with primary and secondary objectives, where the secondary objective is different for each of the N sets of ensemble members. Also, for each subset of ensemble members that comprises more than one ensemble member of the base network, the one or more processor units may be programmed further to jointly train the ensemble members of the subset, such as by adding a joint optimization network to the ensemble members.

In various implementations, for each of the n=1, . . . , N subsets of the ensemble members, the secondary objective for the n-th subset of ensemble members may train the n-th subset of ensemble members such that partial derivatives of a differentiable function attempt to match a target input sensitivity value for each input variable for each training data item, where the differentiable function is different from a loss function for the primary objective. The target input sensitivity value may be a vector that is different for each of the N sets of ensemble members.

In various implementations, the one or more processor units are programmed to train the N subsets with the primary objectives by, for each of the n=1, . . . , N subsets: (i) for each of a plurality of training data examples: (a) computing output values of the n-th subset; (b) computing a partial derivative of the differentiable function of the output values for the n-th subset with respect to an input variable; and (c) computing a partial derivative of the secondary objective for the n-th subset, wherein the secondary objective is a function of one or more computed partial derivatives of the differentiable function; and then (ii) updating a learned parameter for the n-th subset based on, in part, the computed partial derivatives of the secondary objective. Where each of the N subsets comprises a neural network, the output-values of the n-th subset may be computed through a forward computation through the neural network of n-th subset; the partial derivative of the differential function of the output values for the n-th subset may be computed in a back-propagation through the neural network of n-th subset; and the partial derivative of the secondary objective for the n-th subset may be computed through a forward propagation through the neural network of the n-th subset.

Also in various implementations, the one or more processor units are programmed to compute the measure performance and the diversity measure for the n-th subset by: (i) computing a value of an objective of an output of the n-th subset for each of a plurality of selected data items; (ii) accumulating performance data for the n-th subset obtained for all of the selected data items; and (iii) computing a diversity measure of input sensitivity for the n-th subset. In various embodiments, the performance measure of the n-th subset may be computed based on the accumulated performance data for the n-th subset; the first subset of the ensemble members that passes a performance measure test is included in the operational set; and the performance measure test is based on the performance measure. Also, each subset after the first subset that passes both the performance measure test and a diversity test may be included in the operational set, such that there are P subsets in the operational set, where 2<P<J. Also, the diversity test for the n-th subset may be based the diversity measure for the n-th subset and the diversity test may comprise a correlation of a classification gradient for the n-th subset to a classification gradient of each subset already included in the operational set. Also, the performance test may comprise a one-sided null hypothesis test that the n-th subset performs at least as well as an average performance of other subsets that have the same number of ensemble members at the n-th subset.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A method for building and using an operational ensemble of machine learning systems that is robust against adversarial attacks, the method comprising:
training, with a computer system that comprises one or more processor units, a base ensemble having a plurality of machine-learning ensemble members such that the ensemble members have diversity with regard to sensitivity to changes in input variables, wherein the base ensemble comprises N>1 different subsets of the plurality of machine-learning ensemble members, wherein each of the N subsets comprises one or more ensemble members of the plurality of machine-learning ensemble members;
including, by the computer system, P of the N subsets of the ensemble members in the operational ensemble, where 2≤P≤N, based on whether the subsets pass a performance measure test and a diversity measure test, wherein the diversity measure test is based on a diversity measure for the subsets relative to each of the other subsets of the ensemble members; and
performing an operational machine-learning task with the operational ensemble on a data item, wherein performing the operational machine-learning task comprises:
selecting, by the computer system, one of the P subsets of the ensemble members in the operational ensemble; and
processing, by the computer system, the data item with the selected subset of the ensemble members to generate a final result for the machine-learning task for the data item.

2. The method of claim 1, wherein including the P subsets in the operational ensemble comprises:
computing, by the computer system, a performance measure of a first (n=1) subset of the ensemble members; and
for n=2 to J, where P≤J≤N, iteratively:
computing, by the computer system, a performance measure for the n-th subset of the ensemble members;
computing, by the computer system, the diversity measure for the n-th subset of the ensemble members relative to each of the n=1, . . . , (n−1) subsets of the ensemble members; and
determining, by the computer system, whether to include the n-th subset of the ensemble members in the operational ensemble based on the performance and diversity measures for the n-th subset of the ensemble members, such that following the n=J iteration, the operational ensemble comprises the P subsets of the ensemble members.

3. The method of claim 1, wherein, upon a condition that the selected subset comprises multiple ensemble members, the step of processing the data item comprises:
processing the data item with each of the multiple ensemble members of the selected subset; and
combining a result from each of the multiple ensemble members to generate the final result.

4. The method of claim 1, wherein the at least one of the plurality of ensemble members comprises a neural network.

5. The method of claim 1, wherein the each of the plurality of ensemble members comprises a neural network.

6. The method of claim 1, wherein the each of the plurality of ensemble members is a machine learning system training by back propagation of partial derivatives.

7. The method of claim 1, further comprising, prior to training the base ensemble, building, by the computer system, the base ensemble from a base machine-learning network.

8. The method of claim 7, wherein building the base ensemble comprises:
selecting, by the computer system, r selected network elements of a base-machine learning network, where r≥1;
making, by the computer system, M copies of a base machine-learning network, where 2≤M≤2^{r};
training, by the computer system, each of the M copies of the base machine-learning network such that each of the M copies of the base machine-learning network is trained to change its learned parameters in a different direction than any of the other M copies; and
combining, by the computer system, the M copies of the base machine-learning network into the base ensemble.

9. The method of claim 8, wherein:
the base machine-learning network comprises a base neural network;
the base neural network comprises a plurality of nodes and plurality of directed arcs;
each directed arc is between two nodes of the base neural network; and
the t selected network elements comprise u nodes of the base neural network and v directed arcs of the base neural network, where u and v are integers greater than or equal to zero, and where u+v=t.

10. The method of claim 1, wherein training the base ensemble such that the ensemble members have diversity with regard to sensitivity to changes in input variables comprises training each of the N subsets of the ensemble members with primary and secondary objectives, wherein the secondary objective is different for each of the N sets of ensemble members.

11. The method of claim 1, further comprising, for each subset of ensemble members that comprises more than one ensemble member of the base network, training the set comprises jointly training the ensemble members of the subset.

12. The method of claim 11, wherein jointly training the ensemble members comprises adding a joint optimization network to the ensemble members.

13. The method of claim 10, wherein:
for each of the n=1, . . . , N subsets of the ensemble members, the secondary objective for the n-th subset of ensemble members trains the n-th subset of ensemble members such that partial derivatives of a differentiable function attempt to match a target input sensitivity value for each input variable for each training data item; and
the differentiable function is different from a loss function for the primary objective.

14. The method of claim 13, wherein the target input sensitivity value is a vector that is different for each of the N sets of ensemble members.

15. The method of claim 13, wherein training the N subsets with the primary objectives comprises, for each of the n=1, . . . , N subsets:
for each of a plurality of training data examples:
computing, by the computer system, output values of the n-th subset;
computing, by the computer system, a partial derivative of the differentiable function of the output values for the n-th subset with respect to an input variable; and
computing, by the computer system, a partial derivative of the secondary objective for the n-th subset, wherein the secondary objective is a function of one or more computed partial derivatives of the differentiable function; and
updating, by the computer system, a learned parameter for the n-th subset based on, in part, the computed partial derivatives of the secondary objective.

16. The method of claim 15, wherein:
each of the N subsets comprises a neural network;
the output-values of the n-th subset are computed through a forward computation through the neural network of n-th subset;
the partial derivative of the differential function of the output values for the n-th subset is computed in a back-propagation through the neural network of n-th subset; and
the partial derivative of the secondary objective for the n-th subset is computed through a forward propagation through the neural network of the n-th subset.

17. The method of claim 2, wherein the steps of computing the performance measure and the diversity measure for the n-th subset comprises:
computing, by the computer system, a value of an objective of an output of the n-th subset for each of a plurality of selected data items;
accumulating, by the computer system, performance data for the n-th subset obtained for all of the selected data items; and
computing, by the computer system, a diversity measure of input sensitivity for the n-th subset.

18. The method of claim 17, wherein:
the performance measure of the n-th subset is computed based on the accumulated performance data for the n-th subset;
the first subset of the ensemble members that passes a performance measure test is included in the operational set; and
the performance measure test is based on the performance measure.

19. The method of claim 18, wherein each subset after the first subset that passes both the performance measure test and a diversity test are included in the operational set, such that there are P subsets in the operational set, where 2≤P≤J.

20. The method of claim 19, wherein the diversity test for the n-th subset is based the diversity measure for the n-th subset.

21. The method of claim 20, wherein the diversity test comprises a correlation of a classification gradient for the n-th subset to a classification gradient of each subset already included in the operational set.

22. The method of claim 21, wherein the performance test comprises a one-sided null hypothesis test that the n-th subset performs at least as well as an average performance of other subsets that have the same number of ensemble members at the n-th subset.

23. The method of claim 1, selecting one of the P subsets comprises randomly selecting, by the computer system, one of the P subsets of the ensemble members in the operational ensemble.

24. A computer system for building and using an operational ensemble of machine learning systems that is robust against adversarial attacks, the computer system comprising one or more processor units that are programmed to:
train a base ensemble having a plurality of machine-learning ensemble members such that the ensemble members have diversity with regard to sensitivity to changes in input variables, wherein the base ensemble comprises N>1 different subsets of the plurality of machine-learning ensemble members, wherein each of the N subsets comprises one or more ensemble members of the plurality of machine-learning ensemble members;
include P of the N subsets of the ensemble members in the operational ensemble, where 2≤P≤N, based on whether the subsets pass a performance measure test and a diversity measure test, wherein the diversity measure test is based on a diversity measure for the subsets relative to each of the other subsets of the ensemble members; and
perform an operational machine-learning task with the operational ensemble on a data item by:
selecting one of the P subsets of the ensemble members in the operational ensemble; and
processing the data item with the selected subset of the ensemble members to generate a final result for the machine-learning task for the data item.

25. The computer system of claim 24, wherein the one or more processor units of the computer system are programmed to include the P subsets in the operational ensemble by: computing a performance measure of a first (n=1) subset of the ensemble members; and for n=2 to J, where P≤J≤N, iteratively:
computing a performance measure for the n-th subset of the ensemble members;
computing the diversity measure for the n-th subset of the ensemble members relative to each of the n=1, . . . , (n−1) subsets of the ensemble members; and
determining whether to include the n-th subset of the ensemble members in the operational ensemble based on the performance and diversity measures for the n-th subset of the ensemble members, such that following the n=J iteration, the operational ensemble comprises the P subsets of the ensemble members.

26. The computer system of claim 24, wherein, upon a condition that the selected subset comprises multiple ensemble members, the computer system processes the data item by:
processing the data item with each of the multiple ensemble members of the selected subset; and
combining a result from each of the multiple ensemble members to generate the final result.

27. The computer system of claim 24, wherein the one or more processor units of the computer system are further programmed to, prior to training the base ensemble, build the base ensemble from a base machine-learning network.

28. The computer system of claim 27, wherein the one or more processor units are programmed to build the base ensemble by:
selecting r selected network elements of a base-machine learning network, where r≥1;
making M copies of a base machine-learning network, where 2≤M≤2^{r};
training each of the M copies of the base machine-learning network such that each of the M copies of the base machine-learning network is trained to change its learned parameters in a different direction than any of the other M copies; and
combining the M copies of the base machine-learning network into the base ensemble.

29. The computer system of claim 28, wherein:
the base machine-learning network comprises a base neural network;
the base neural network comprises a plurality of nodes and plurality of directed arcs;
each directed arc is between two nodes of the base neural network; and
the t selected network elements comprise u nodes of the base neural network and v directed arcs of the base neural network, where u and v are integers greater than or equal to zero, and where u+v=t.

30. The computer system of claim 24, wherein the one or more processor units are programmed to train the base ensemble such that the ensemble members have diversity with regard to sensitivity to changes in input variables by training each of the N subsets of the ensemble members with primary and secondary objectives, wherein the secondary objective is different for each of the N sets of ensemble members.

31. The computer system of claim 24, wherein the one or more processor units are programmed further to, for each subset of ensemble members that comprises more than one ensemble member of the base network, jointly train the ensemble members of the subset.

32. The computer system of claim 31, wherein the one or more processor units are programmed to jointly train the ensemble members by adding a joint optimization network to the ensemble members.

33. The computer system of claim 30, wherein:
for each of the n=1, . . . , N subsets of the ensemble members, the secondary objective for the n-th subset of ensemble members trains the n-th subset of ensemble members such that partial derivatives of a differentiable function attempt to match a target input sensitivity value for each input variable for each training data item; and
the differentiable function is different from a loss function for the primary objective.

34. The computer system of claim 33, wherein the target input sensitivity value is a vector that is different for each of the N sets of ensemble members.

35. The computer system of claim 33, wherein the one or more processor units are programmed to train the N subsets with the primary objectives by, for each of the n=1, . . . , N subsets:
for each of a plurality of training data examples:
computing output values of the n-th subset;
computing a partial derivative of the differentiable function of the output values for the n-th subset with respect to an input variable; and
computing a partial derivative of the secondary objective for the n-th subset, wherein the secondary objective is a function of one or more computed partial derivatives of the differentiable function; and
updating a learned parameter for the n-th subset based on, in part, the computed partial derivatives of the secondary objective.

36. The computer system of claim 35, wherein:
each of the N subsets comprises a neural network;
the output-values of the n-th subset are computed through a forward computation through the neural network of n-th subset;
the partial derivative of the differential function of the output values for the n-th subset is computed in a back-propagation through the neural network of n-th subset; and
the partial derivative of the secondary objective for the n-th subset is computed through a forward propagation through the neural network of the n-th subset.

37. The computer system of claim 25, wherein the one or more processor units are programmed to compute the measure performance and the diversity measure for the n-th subset by:
computing a value of an objective of an output of the n-th subset for each of a plurality of selected data items;
accumulating performance data for the n-th subset obtained for all of the selected data items; and
computing a diversity measure of input sensitivity for the n-th subset.

38. The computer system of claim 37, wherein:
the performance measure of the n-th subset is computed based on the accumulated performance data for the n-th subset;
the first subset of the ensemble members that passes a performance measure test is included in the operational set; and
the performance measure test is based on the performance measure.

39. The computer system of claim 38, wherein each subset after the first subset that passes both the performance measure test and a diversity test are included in the operational set, such that there are P subsets in the operational set, where 2≤P≤J.

40. The computer system of claim 39, wherein the diversity test for the n-th subset is based the diversity measure for the n-th subset.

41. The computer system of claim 40, wherein the diversity test comprises a correlation of a classification gradient for the n-th subset to a classification gradient of each subset already included in the operational set.

42. The computer system of claim 41, wherein the performance test comprises a one-sided null hypothesis test that the n-th subset performs at least as well as an average performance of other subsets that have the same number of ensemble members at the n-th subset.

43. The computer system of claim 24, wherein the one or more processor units select one of the P subsets by randomly selecting one of the P subsets of the ensemble members in the operational ensemble.
